(19) United States
(12) Patent Application Publication
(10) Pub. No.: US 2026/0172716 A1
(43) Pub. Date: Jun. 18, 2026

(54) SOLID-STATE IMAGING DEVICE

(71) Applicant: SAMSUNG ELECTRONICS CO., LTD., Suwon-si (KR)

(72) Inventor: Itaru Oshima, Yokohama (JP)

(73) Assignee: SAMSUNG ELECTRONICS CO., LTD., Suwon-si (KR)

(21) Appl. No.: 19/425,288

(22) Filed: Dec. 18, 2025

(30) Foreign Application Priority Data
Dec. 18, 2024 (JP) 2024-221373

(51) Int. Cl. H04N 25/773; H04N 25/50; H04N 25/771

(52) U.S. Cl. CPC H04N 25/773; H04N 25/50; H04N 25/771

(57) ABSTRACT

A solid-state imaging device includes a pixel array in which a plurality of pixels are arranged, and a counter unit. Each of the plurality of pixels includes a single-photon avalanche diode (SPAD). The counter unit includes a counter data generation circuit corresponding to the SPAD, and a memory unit. The memory unit includes a counter corresponding to each of the plurality of pixels. The counter data generation circuit is configured to perform addition processing that sequentially performs carry addition for each designated digit during counting of a number of photons incident on the SPAD, and recording processing that sequentially records an addition result in the counter for each designated digit.

### CROSS-REFERENCE TO RELATED APPLICATIONS

This application is based on and claims priority under 35 U.S.C. § 119 to Japanese Patent Application No. 2024-221373, filed on Dec. 18, 2024, in the Japan Patent Office, the disclosure of which is incorporated by reference herein in its entirety.

### BACKGROUND

The disclosure relates to a solid-state imaging device.

Recently, a solid-state imaging device using a single-photon avalanche diode (SPAD) as a photoelectric conversion element has been attracting attention. Since the number of incident photons is output as a count in the SPAD, high sensitivity may be achieved even under low-illuminance imaging conditions. Although there is a limitation in integration density, increasing the size of the counter allows imaging without saturation, even under high-illuminance imaging conditions, and thus a wide dynamic range may be achieved.

In a related art, an image sensor is disclosed in which, when using an SPAD, a counter is arranged outside a pixel region to reduce the number of circuits within the pixel region. This enables the image sensor to include a plurality of pixels with a small pixel pitch and to obtain a high-resolution image signal. However, in such an image sensor, a counter circuit, such as a ripple counter, is used, and memory is not used.

### SUMMARY

According to an aspect of the disclosure, there is provided a solid-state imaging device including a pixel array in which a plurality of pixels are arranged, and a counter unit, wherein each of the plurality of pixels includes a single-photon avalanche diode (SPAD), the counter unit includes a counter data generation circuit corresponding to the SPAD, and a memory unit, the memory unit includes a counter corresponding to each of the plurality of pixels, and the counter data generation circuit is configured to perform addition processing that sequentially performs carry addition for each designated digit during counting of a number of photons incident on the SPAD, and recording processing that sequentially records an addition result in the counter for each designated digit.

According to another aspect of the disclosure, there is provided a method of operating a solid-state imaging device including a pixel array in which a plurality of pixels are arranged, and a memory unit, wherein each of the plurality of pixels includes an SPAD, the method including setting an exposure time of a next frame based on illuminance detected in a previous frame, performing exposure in the SPAD during the set exposure time, performing addition processing that sequentially performs carry addition for each designated digit during counting of a number of photons incident on the SPAD during the exposure time, performing recording processing that sequentially records a result of the addition processing in a counter of the memory unit for each designated digit, and generating image data based on the exposure time and a count value of the number of photons.

According to another aspect of the disclosure, there is provided a counter unit including a counter data generation circuit, a static random-access memory (SRAM), and a memory control circuit, wherein the counter data generation circuit is configured to perform addition processing that sequentially performs carry addition for each designated digit, based on address control by the memory control circuit, during counting of a number of photons input to an SPAD of each pixel for an exposure time, and perform recording processing that sequentially records a result of the addition processing in the SRAM for each designated digit based on the address control.

### BRIEF DESCRIPTION OF THE DRAWINGS

Embodiments will be more clearly understood from the following detailed description taken in conjunction with the accompanying drawings in which:

FIG. 1 is a schematic diagram of a solid-state imaging device of a first embodiment, according to an embodiment;

FIG. 2 is a schematic diagram of a counter unit and a driving circuit, according to an embodiment;

FIG. 3 is a schematic diagram of a counter unit according to an embodiment;

FIG. 4A is a table illustrating an example of a frame period with respect to an exposure time and a number of counter bits (maximum count value), according to an embodiment;

FIG. 4B is a table obtained by converting the table of FIG. 4A to a frame rate, according to an embodiment;

FIG. 4C is a table illustrating an example of a minimum detectable illuminance with respect to an exposure time and a number of counter bits (maximum count value), according to an embodiment;

FIG. 5 is a schematic diagram of a counter unit according to an embodiment;

FIG. 6 is a flowchart of imaging processing according to an embodiment;

FIG. 7 is a flowchart of a subroutine of operation S3 in FIG. 6, according to an embodiment;

FIG. 8 is a table illustrating an example of a counter transition during one cycle of imaging processing, according to an embodiment;

FIG. 9 is a time chart illustrating a timing of counting processing according to an embodiment;

FIG. 10A is a time chart illustrating an example of counting processing during one exposure cycle according to an embodiment;

FIG. 10B is a table illustrating carry and addition processing performed a number of times corresponding to a number of bits, in correspondence with the time chart of FIG. 10A;

FIG. 10C is a time chart illustrating another example of counting processing during one exposure cycle according to an embodiment;

FIG. 10D is a table illustrating carry and addition processing performed a number of times corresponding to a number of bits, in correspondence with the time chart of FIG. 10C, according to an embodiment;

FIG. 11 is a table illustrating an example of an exposure-time setting range according to an embodiment;

FIG. 12 is a schematic diagram of an illuminance determination circuit and an exposure control circuit according to an embodiment;

FIG. 13A is a time chart illustrating exposure-time setting processing of an illuminance determination circuit and an exposure control circuit, according to an embodiment;

FIG. 13B is a time chart illustrating exposure-time setting processing of an illuminance determination circuit and an exposure control circuit, according to an embodiment;

FIG. 14A is a time chart illustrating exposure-time setting processing of an illuminance determination circuit and an exposure control circuit, according to an embodiment;

FIG. 14B is a time chart illustrating exposure-time setting processing of an illuminance determination circuit and an exposure control circuit, according to an embodiment;

FIG. 15A is a time chart illustrating exposure-time setting processing of an illuminance determination circuit and an exposure control circuit, according to an embodiment;

FIG. 15B is a time chart illustrating exposure-time setting processing of an illuminance determination circuit and an exposure control circuit, according to an embodiment;

FIG. 16 is a time chart illustrating exposure-time setting processing of an illuminance determination circuit and an exposure control circuit across multiple frames, according to an embodiment;

FIG. 17 is a schematic diagram of a counter data generation circuit for 1-bit connection according to an embodiment;

FIG. 18 is a diagram illustrating an example of a memory map of a 16-bit counter within a static random-access memory (SRAM) in a connection configuration of FIG. 17, according to an embodiment;

FIG. 19 is a table illustrating an example of mapping between each pixel and the memory map of FIG. 18, according to an embodiment;

FIG. 20A is a schematic diagram of a counter data generation circuit for 2-bit connection according to an embodiment;

FIG. 20B is a diagram illustrating an example of a memory map of a 16-bit counter within an SRAM in a connection configuration of FIG. 20A, according to an embodiment;

FIG. 21A is a schematic diagram of a counter data generation circuit for 4-bit connection, according to an embodiment;

FIG. 21B is a diagram illustrating an example of a memory map of a 16-bit counter within an SRAM in a connection configuration of FIG. 21A, according to an embodiment;

FIG. 22A is a schematic diagram of a counter data generation circuit for 8-bit connection according to an embodiment;

FIG. 22B is a diagram illustrating an example of a memory map of a 16-bit counter within an SRAM in a connection configuration of FIG. 22A, according to an embodiment;

FIG. 23 is a timing chart illustrating a timing of counter processing of the first embodiment, according to an embodiment;

FIG. 24 is a timing chart illustrating a timing of counter processing of variation 2, according to an embodiment;

FIG. 25 is a table illustrating variation 3 according to an embodiment;

FIG. 26 is a schematic diagram of a solid-state imaging device including an SPAD data selection circuit of a second embodiment, according to an embodiment;

FIG. 27 is a schematic diagram of an SPAD data selection circuit and a counter unit according to an embodiment;

FIG. 28 is a schematic diagram of an illuminance determination circuit and an exposure control circuit according to an embodiment;

FIG. 29A is a table illustrating an example of a number of counter bits assigned to each pixel in a pixel array, according to an embodiment;

FIG. 29B is a schematic diagram illustrating a circuit configuration of an SPAD data selection circuit according to an embodiment;

FIG. 29C illustrates an example of a memory map within an SRAM in a connection configuration of embodiment 2-11, according to an embodiment;

FIG. 30A is a table illustrating another example of a number of counter bits assigned to each pixel in a pixel array according to an embodiment;

FIG. 30B is a schematic diagram illustrating a circuit configuration of an SPAD data selection circuit, according to an embodiment;

FIG. 30C is a diagram illustrating an example of a memory map within an SRAM in a connection configuration of embodiment 2-12, according to an embodiment;

FIG. 31A is a table illustrating another example of a number of counter bits assigned to each pixel in a pixel array according to an embodiment;

FIG. 31B is a schematic diagram illustrating a circuit configuration of an SPAD data selection circuit, according to an embodiment;

FIG. 31C illustrates an example of a memory map within an SRAM in a connection configuration of embodiment 2-13, according to an embodiment;

FIG. 32A is a table illustrating another example of a number of counter bits assigned to each pixel in a pixel array according to an embodiment;

FIG. 32B is a schematic diagram illustrating a circuit configuration of an SPAD data selection circuit according to an embodiment;

FIG. 32C illustrates an example of a memory map within an SRAM in a connection configuration of embodiment 2-14, according to an embodiment;

FIG. 33A is a table illustrating another example of a number of counter bits assigned to each pixel in a pixel array according to an embodiment;

FIG. 33B is a schematic diagram illustrating a circuit configuration of an SPAD data selection circuit, according to an embodiment;

FIG. 33C illustrates an example of a memory map within an SRAM in a connection configuration of embodiment 2-15, according to an embodiment;

FIG. 34A is a table illustrating another example of a number of bits of pixels corresponding to a memory map, according to an embodiment;

FIG. 34B is a schematic diagram illustrating a circuit configuration of an SPAD data selection circuit according to an embodiment;

FIG. 34C illustrates an example of a memory map within an SRAM in a connection configuration of embodiment 2-16 according to an embodiment;

FIG. 35 is a schematic diagram of an SPAD data selection circuit and a counter unit in a variation of the second embodiment, according to an embodiment;

FIG. 36A is a table illustrating another example of a number of counter bits assigned to each pixel in a pixel array according to an embodiment;

FIG. 36B is a schematic diagram illustrating a circuit configuration of an SPAD data selection circuit according to an embodiment;

FIG. 36C illustrates an example of a memory map within an SRAM in a connection configuration of embodiment 2-21 according to an embodiment;

FIG. 37A is a table illustrating another example of a number of counter bits assigned to each pixel in a pixel array according to an embodiment;

FIG. 37B is a schematic diagram illustrating a circuit configuration of an SPAD data selection circuit, according to an embodiment;

FIG. 37C illustrates an example of a memory map within an SRAM in a connection configuration of embodiment 2-22 according to an embodiment;

FIG. 38A is a table illustrating another example of a number of counter bits assigned to each pixel in a pixel array according to an embodiment;

FIG. 38B is a schematic diagram illustrating a circuit configuration of an SPAD data selection circuit, according to an embodiment;

FIG. 38C illustrates an example of a memory map within an SRAM in a connection configuration of embodiment 2-23 according to an embodiment;

FIG. 39A is a table illustrating another example of a number of counter bits assigned to each pixel in a pixel array according to an embodiment;

FIG. 39B is a schematic diagram illustrating a circuit configuration of an SPAD data selection circuit, according to an embodiment.

FIG. 39C illustrates an example of a memory map within an SRAM in a connection configuration of embodiment 2-24 according to an embodiment;

FIG. 40A is a table illustrating another example of a number of counter bits assigned to each pixel in a pixel array according to an embodiment;

FIG. 40B is a schematic diagram illustrating a circuit configuration of an SPAD data selection circuit, according to an embodiment; and

FIG. 40C illustrates an example of a memory map within an SRAM in a connection configuration of embodiment 2-25 according to an embodiment.

### DETAILED DESCRIPTION OF THE EMBODIMENTS

Hereinafter, embodiments are described in detail with reference to the accompanying drawings. However, the scope of the disclosure is not limited to the disclosed embodiments. In the following drawings, the same reference numerals denote the same components, and the sizes of the respective components are illustrated differently from their actual proportions for clarity and convenience of explanation. The embodiments described below are merely examples, and various modifications are possible from such embodiments.

In the following description, the terms “upper” or “above” may refer not only to a component that is directly in contact with and positioned above another component, but also to a component that is positioned above another component without direct contact.

A component expressed in the singular form may include a plurality of components unless clearly stated otherwise from the context. In addition, when a part is referred to as “including” or “having” a certain component, it should be understood that, unless explicitly stated otherwise, the part may further include other components rather than excluding the same.

The use of the term “the” or similar referential expressions is intended to encompass both singular and plural forms.

All examples or illustrative terms (e.g., “and the like”) are provided merely for the purpose of illustrating the technical concept, and unless otherwise limited by the claims, the scope of the disclosure should not be construed as being limited by such examples or illustrative terms.

### First Embodiment

### <Configuration of Solid-State Imaging Device 100>

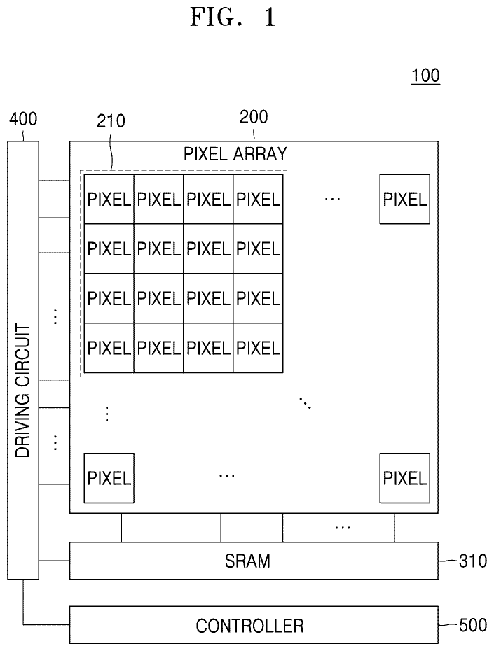

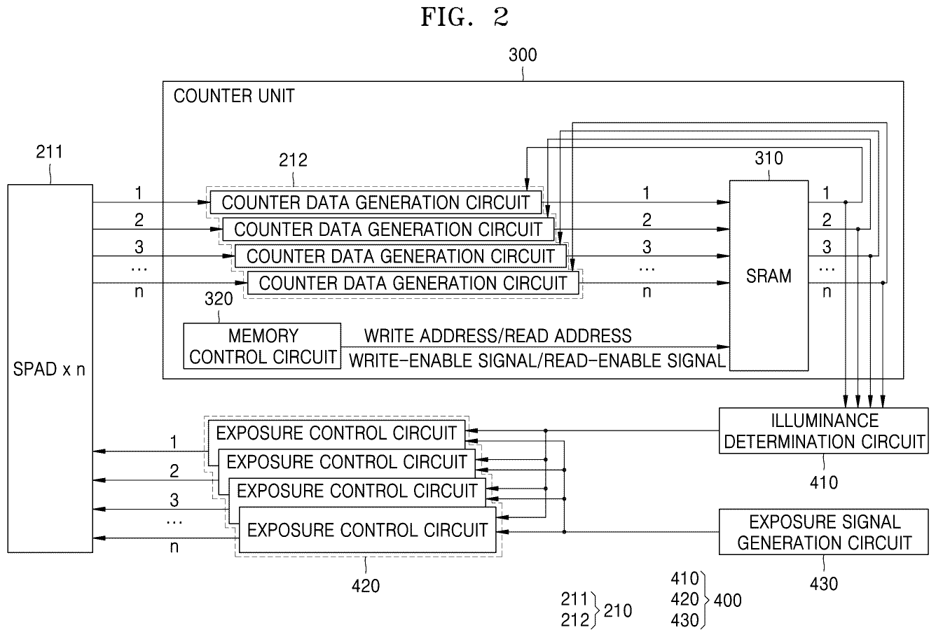

FIG. 1 is a schematic diagram of a solid-state imaging device 100 of a first embodiment, according to an embodiment. FIG. 2 is a schematic diagram of a counter unit 300 and a driving circuit 400, according to an embodiment.

As shown in FIG. 1, the solid-state imaging device 100 includes a pixel array 200, a static random-access memory (SRAM) 310, a driving circuit 400, and a controller 500. In the pixel array 200, a plurality of pixels 210 may be arranged in an array form in a row direction and a column direction (hereinafter, also referred to as an X direction or a horizontal direction and a Y direction or a vertical direction, respectively). Since each of the plurality of pixels 210 includes a single-photon avalanche diode (SPAD), each of the plurality of pixels 210 may hereinafter be referred to as an SPAD pixel. The pixel array 200 may include all of the plurality of pixels 210 (e.g., millions of pixels or more) of the solid-state imaging device 100.

As shown in FIG. 2, the plurality of pixels 210 may include a plurality of SPADs 211 and a plurality of counter data generation circuits 212. The driving circuit 400 may control driving of the plurality of pixels 210.

The plurality of counter data generation circuits 212, the SRAM 310, and a memory control circuit 320 may be included in the counter unit 300. The SRAM 310 may correspond to a memory unit. As the memory unit, magneto-resistive random-access memory (MRAM) may be used, instead of SRAM. Although details are described below, the plurality of counter data generation circuits 212 may perform addition processing and recording processing during counting of the number of photons incident on the plurality of SPADs 211. The addition processing refers to sequentially performing carry addition for each designated digit. The recording processing refers to sequentially recording an addition result in a counter of the SRAM 310 for each designated digit. The memory control circuit 320 may assign, to each respective one of the plurality of pixels 210, a number of memory addresses corresponding to the number of bits through address control. The memory addresses are used as counters. In addition, for the addition processing, the counter unit 300 may add bit data of the designated digits of the counters (memory address) assigned to each respective one of the plurality of pixels 210 and carry bit data corresponding to the designated digits during the counting, based on address control by the memory control circuit 320. For the recording processing, the addition result obtained through the addition processing may be recorded in the designated digit of the counter based on address control by the memory control circuit 320.

The driving circuit 400 may include an illuminance determination circuit 410, a plurality of exposure control circuits 420, and an exposure signal generation circuit 430. As described below, the illuminance determination circuit 410 may determine illuminance from the amount of light incident on each pixel 210. The plurality of exposure control circuits 420 may set an exposure time according to the determined illuminance. The plurality of exposure control circuits 420 may set a short exposure time during one exposure cycle when illuminance is high and may set a long exposure time when illuminance is low, within a range of adjustable exposure times.

The controller 500 may generate image data by calculating the amount of light incident on each the of plurality of pixels 210 based on the count value recorded in the memory unit 310 according to the number of photons incident on one of the plurality of SPADs 211 of corresponding one of the plurality of pixels 210 and the exposure time set by the corresponding one of the plurality of exposure control circuits 420.

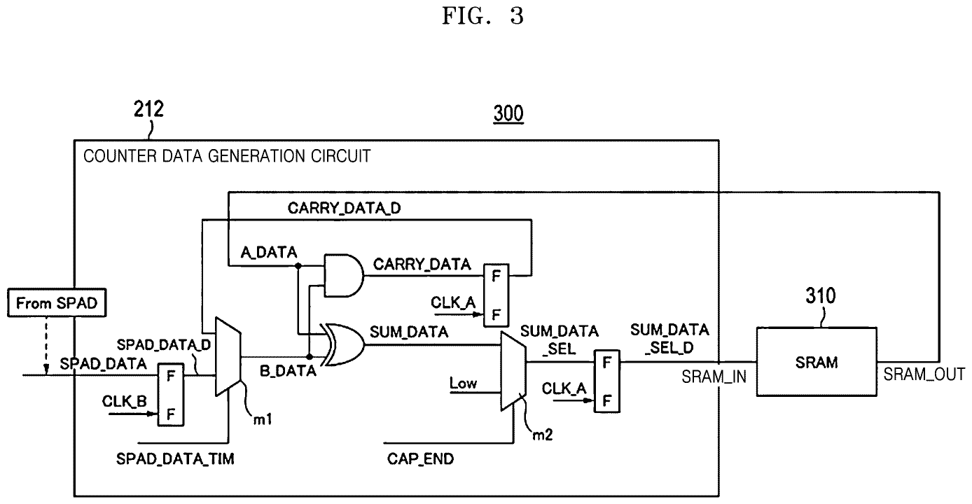

FIG. 3 is a schematic diagram of the counter unit 300 according to an embodiment. The one of the plurality of counter data generation circuits 212 shown may have a function of a half adder.

In an embodiment, an exposure cycle, an exposure time, and a counting processing cycle are provided. Photon detection is performed once during the exposure cycle, which may correspond to a maximum value of the selectable exposure time. Hereinafter, description is made by taking the following conditions as an example. However, each numerical value in these conditions is merely an example and is not limited thereto.
Exposure cycle: 2560 ns,
Exposure time: a certain value within a range of about 10 ns to about 2560 ns,
Counting processing cycle (CLK_A): 16 ns,
Number of bits of counter (hereinafter referred to as “number of counter bits”): 13.

### (Overview of Counting Processing)

In a single imaging processing (hereinafter, referred to as a “frame”), the exposure cycle may be performed a number of times represented by the number of counter bits, for example, 8192 times in the case of 13 bits. During one exposure cycle, exposure is performed by the one of the plurality of SPADs 211 for the exposure time. In addition, during the same exposure cycle, a count (1 or 0) input by exposure may be subjected to addition processing that sequentially performs carry addition for each digit for a number of times corresponding to the number of bits (digits), e.g., 13 digits, and recording processing that sequentially records the addition result in the counter for each digit.

In FIG. 3, CLK_B denotes a signal input during the exposure cycle. CLK_A corresponds to a counter processing cycle. SPAD_DATA_TIM denotes a signal for processing an added photon detection result (SPAD_DATA_D) in accordance with digit-increment timing. While SPAD_DATA_TIM is high, a signal of the one of the plurality of SPADs 211 may be selected and output from a multiplexer m1 and transmitted as B_DATA to the lower AND circuit and XOR circuit. During a period other than the exposure time, a carry signal (CARRY_DATA) indicating the presence or absence of a carry from the AND circuit may be selected from the multiplexer m1 and may be transmitted as B_DATA to the lower AND circuit and XOR circuit.

During a single frame period, an output (SUM_DATA) of the XOR circuit from a multiplexer m2 may be output and transmitted to the lower flip-flop. For the purpose of initializing the count value of the SRAM after determining the number of photons detected during the single frame period, an output of an initial value (Low) may be selected from the multiplexer m2 and transmitted to the lower flip-flop. However, a method of initializing the SRAM is not limited thereto. The method may include other methods, such as resetting the SRAM. During the exposure cycle, the lower flip-flop may receive an input of CLK_A and may loop 13 times corresponding to the number of counter bit digits within the next single exposure cycle to write and read carry addition results to and from the SRAM (SRAM_OUT).

### (Frame Rate and Maximum/Minimum Detectable Illuminance)

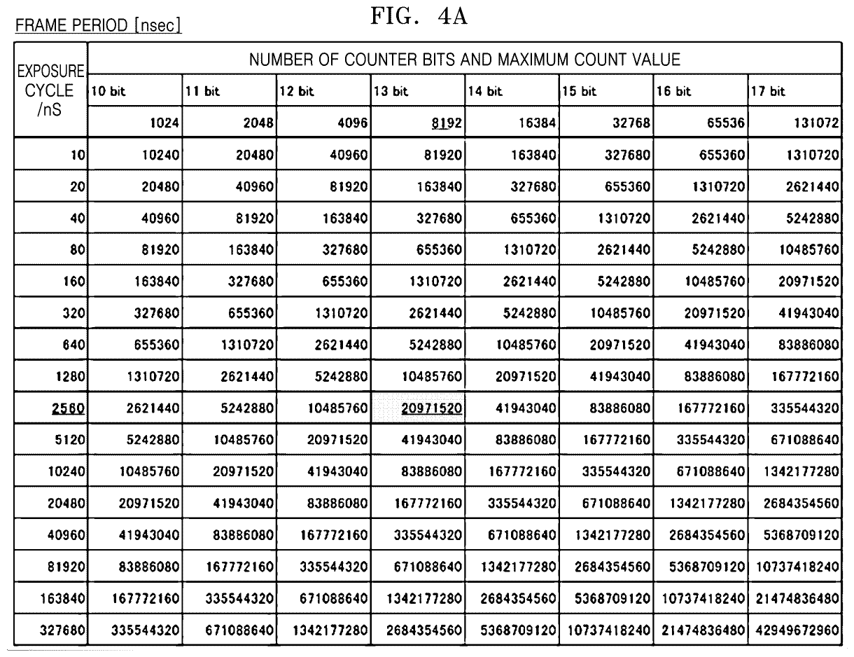

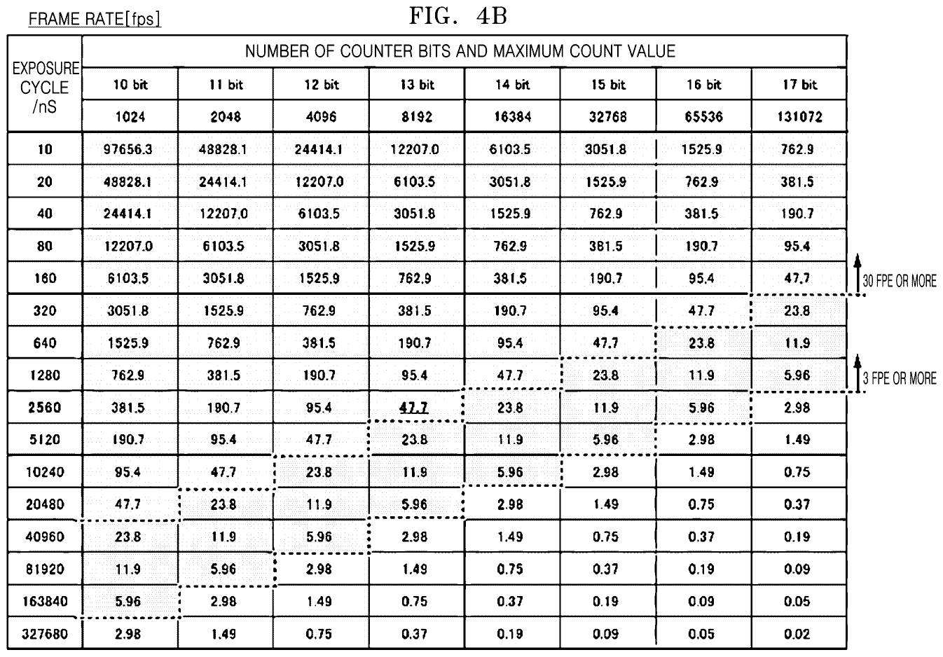

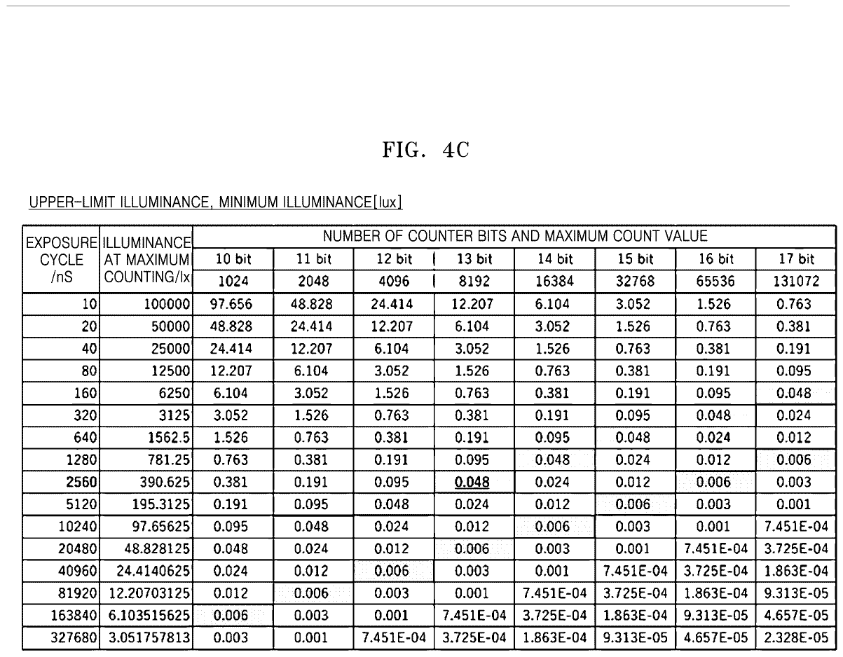

Hereinafter, the frame rate and the maximum/minimum detectable illuminance in combinations of multiple stages of bit numbers and exposure times are described with reference to FIGS. 4A to 4C.

FIG. 4A is a table illustrating an example of a frame period with respect to an exposure time and a number of counter bits (maximum count value), according to an embodiment. In FIG. 4A, the vertical axis represents the exposure cycle, and the horizontal axis represents the number of counter bits. The underlined value corresponds to the above-described example. For example, when the number of counter bits is 13 bits and the maximum count value is 8192 during the exposure cycle (2560 ns), the frame period is equal to 20971520 ns (about 21 ms) obtained by multiplying these values (a shaded (gray) portion in FIG. 4A).

FIG. 4B is a table obtained by converting the table of FIG. 4A to a frame rate (fps), according to an embodiment. General videos may require 30 fps or more, while security videos used in surveillance or monitoring cameras may require 3 fps or more. For example, when the above-mentioned exposure time is 2560 ns and the number of counter bits is 13 bits, up to 47.7 fps may be achieved, and thus the performance of 30 fps or more required for general videos may be achieved.

FIG. 4C is a table illustrating an example of a minimum detectable illuminance with respect to an exposure time and a number of counter bits (maximum count value), according to an embodiment. In addition, FIG. 4C also illustrates the illuminance during the maximum counting for each exposure time. For general videos, about 0.05 [lx] is required, and for security videos used in surveillance or monitoring cameras, about 0.005 [lx] is required. For example, when the exposure time is 2560 ns and the number of counter bits is 13 bits, up to 0.048 [lx] may be achieved, and thus the performance of about 0.05 [lx] required for general videos may be achieved.

### (Counter Unit 300)

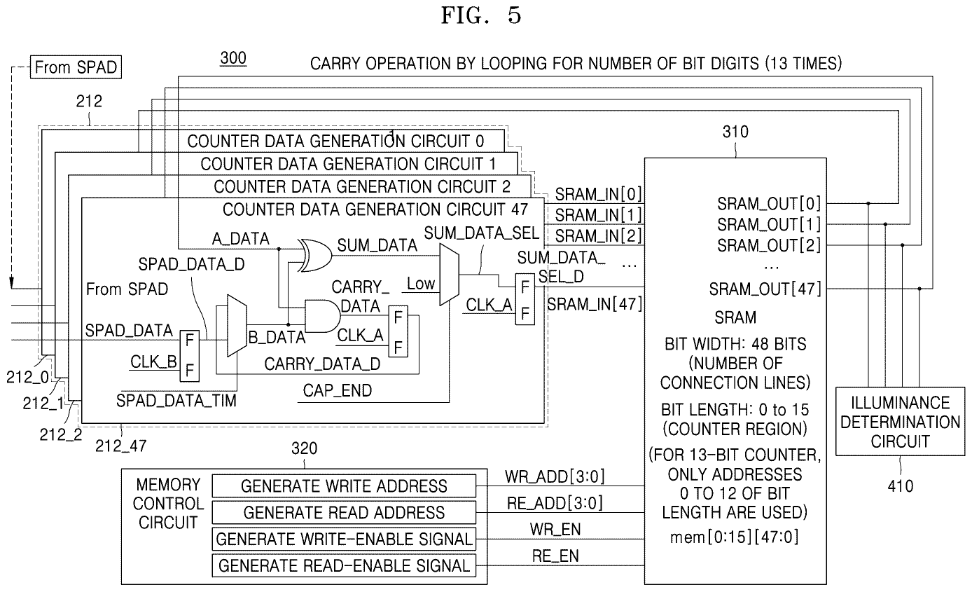

FIG. 5 is a schematic diagram of the counter unit 300 according to an embodiment. In FIG. 5, the counter unit 300 where the pixel array 200 has 48 pixels 210 (=8 pixels horizontally×6 pixels vertically) is shown. Additionally, as described above, it is assumed that the number of counter bits is 13 bits, the exposure cycle is 2560 ns, and the exposure time is about 10 ns to about 2560 ns. A total of 48 counter data generation circuits (e.g., 212_0 to 212_47) may each be connected to the SRAM 310 by one bit, wherein the number following the underscore may indicate an individual counter data generation circuit, and the same applies to pixels (e.g., 210_0) described below. That is, the bit width corresponds to 48 bits. As a counter for each pixel 210, bit lengths (0 to 15) may be secured in the SRAM 310, and, as one example, only 13 bits (0 to 12) may be used. The memory control circuit 320 designates write and read addresses secured in the SRAM 310 in accordance with the timing and generates write-and read-enable signals.

### (Imaging Processing)

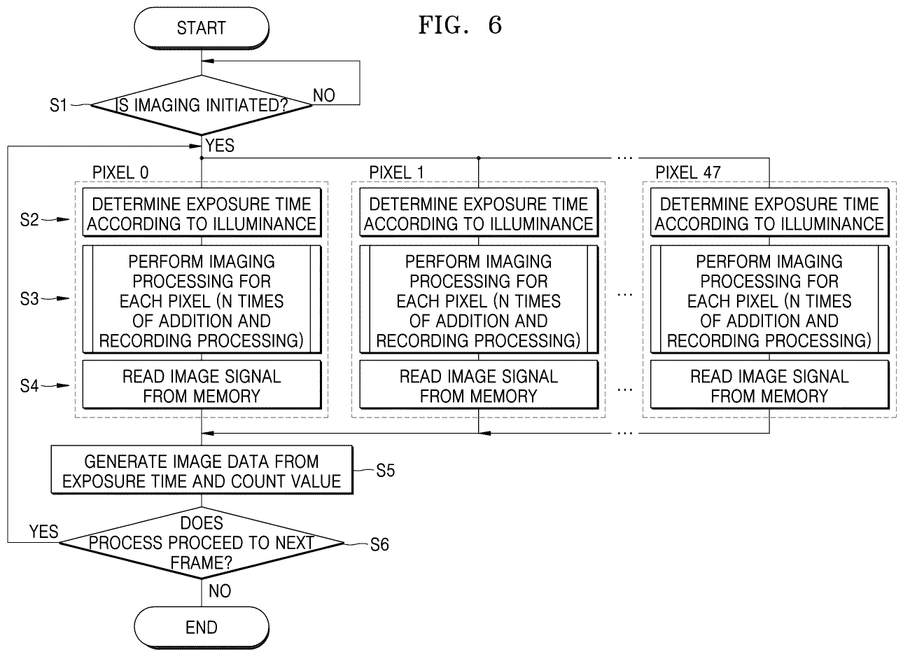

Hereinafter, the imaging processing performed by the solid-state imaging device 100 is described with reference to FIGS. 6 to 14B. Hereinafter, processing for a case where the number of plurality of pixels 210 in the pixel array 200 is 48 is described with reference to FIG. 5. However, the number 48 is merely an example. The pixel array 200 may include tens of millions of pixels or more.

### (Operation S1)

FIG. 6 is a flowchart of imaging processing according to an embodiment. When imaging is initiated (operation S1: YES), the imaging processing may proceed to the next operation S2, and operations S2 to S4 may be performed in parallel for each of the plurality of pixels 210.

### (Operation S2)

For each of pixels 210_0 to 210_47, the exposure time of the next frame may be set according to the illuminance in the previous frame detected by the illuminance determination circuit 410 for each of the plurality of pixels 210. In the first cycle, an initial exposure time, for example, 10 ns, may be set. For example, when the illuminance in the previous frame is high and the count value is high, the shortest exposure time of 10 ns within the settable range of about 10 ns to about 2560 ns may be set. Thus, as the illuminance decreases, the exposure time may be set in the order of 20 ns, 40 ns, 80 ns, . . . , 2560 ns. A detailed description of the setting of the exposure time according to the illuminance is given below.

### (Operation S3)

The imaging processing for each pixel may be performed.

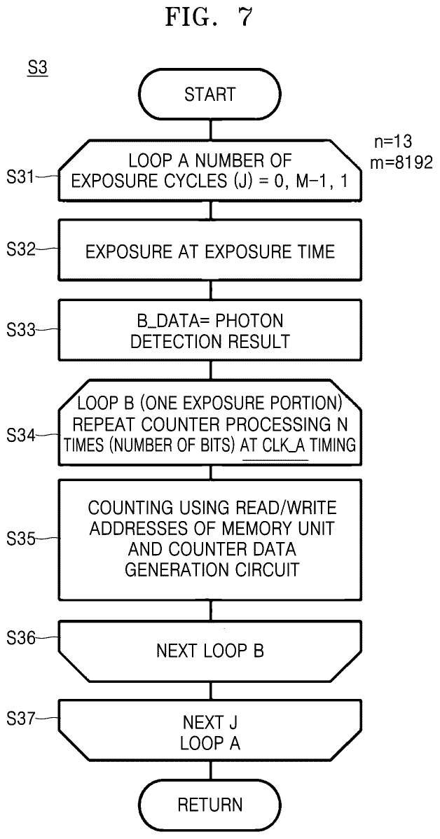

FIG. 7 is a flowchart of a subroutine of operation S3 in FIG. 6, according to an embodiment.

### (Loop A (Operations S31 to S37))

The processing of loop A, performed in operations S31 to S37, may be repeated as the number of exposure cycles (j) increases by 1 from an initial value of 0 to m-1. For example, when the exposure cycle is 2560 ns and the number of bits is 13 bits (i.e., n=13 bits), m may correspond to the maximum value representable by 13 bits, which is 8192 (2 to the power of 13). For example, the processing of loop A may be executed once during one exposure cycle period, and this may be repeated m times. The entire processing of loop A (exposure cycle (ns)×m) may be performed during the frame period shown in the table of FIG. 4A.

### (Operation S32)

The plurality of SPADs 211 may perform exposure for the exposure time set in operation S2.

### (Operation S33)

The digital output (output signal) from one of the plurality of SPADs 211 may be input to B_DATA. When a photon is incident on the one of the plurality of SPADs 211 during the exposure time, “1” may be input to B_DATA, and when a photon is not incident thereon, “0” may be input to B_DATA.

### (Loop B (Operations S34 to S36))

The processing of loop B includes counter processing and is repeated n times (the number of bit digits) in accordance with the timing of CLK_A.

### (Operation S35)

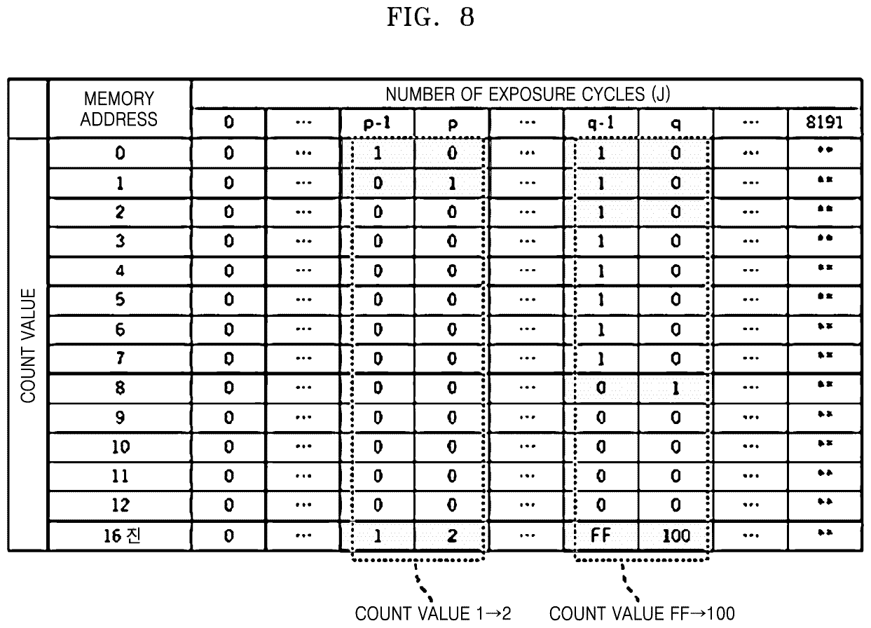

The counting processing may be performed using reading from a read address and writing to a write address of the SRAM 310 designated by the memory control circuit 320, together with the plurality of counter data generation circuits 212. Hereinafter, the counting processing is described with reference to FIGS. 8 to 10D.

### (Counting Processing)

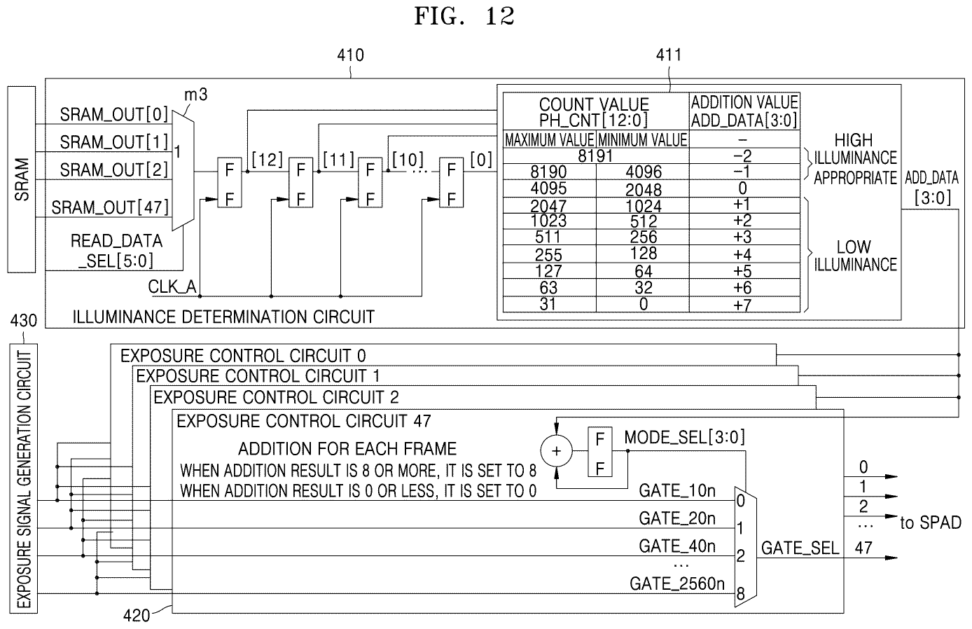

FIG. 8 is a table illustrating an example of a counter transition during one cycle of imaging processing, according to an embodiment. The memory control circuit 320 may secure 13 counters from address 0 to address 12 for each of the plurality of pixels 210 in the SRAM 310, according to the 13-bit digits. As described above, in one frame, the number of exposure cycles (j) may be repeated m times (8192 times). According to the number of exposure cycles (j), exposure may be performed for the exposure time set in response to the illuminance as described above, and when a photon is incident on the one of the plurality of SPADs 211 during this time, one count-up may be performed in accordance with the output digital signal. That is, the counting may be incremented up to 8191. However, since the exposure time is typically set by the illuminance determination circuit 410 to enable high-sensitivity imaging without saturation, the memory control circuit 320 may be designed such that, unless there is a rapid change in luminance within a short period of time, the count value falls within a range of about one-fourth to about one-half of the maximum count value (see the table of FIG. 12). Hereinafter, representative cases where the count value changes from 0 to 1 and from FF to 100 (hexadecimal) are described.

### (Timing of Counting Processing)

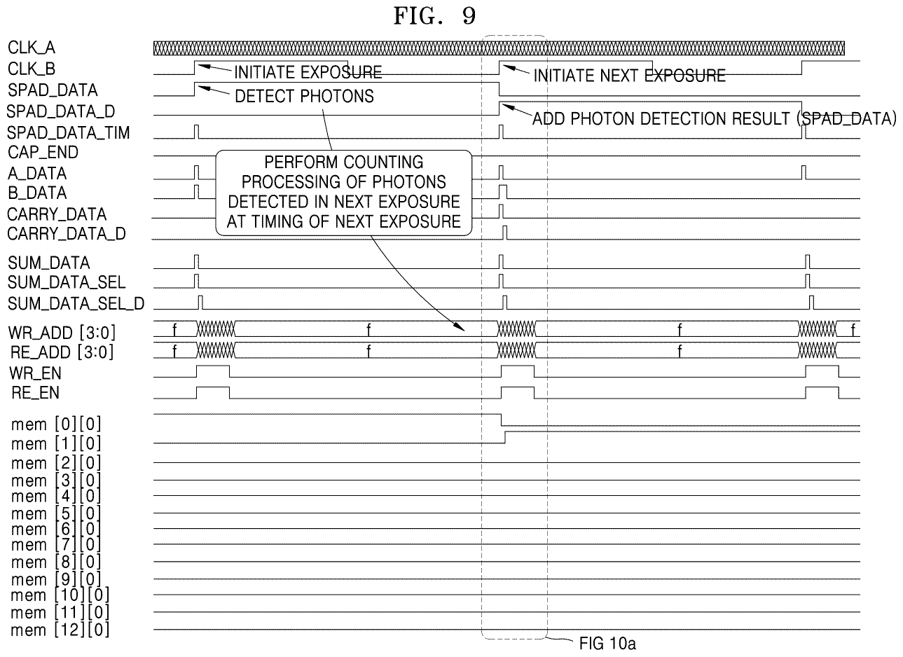

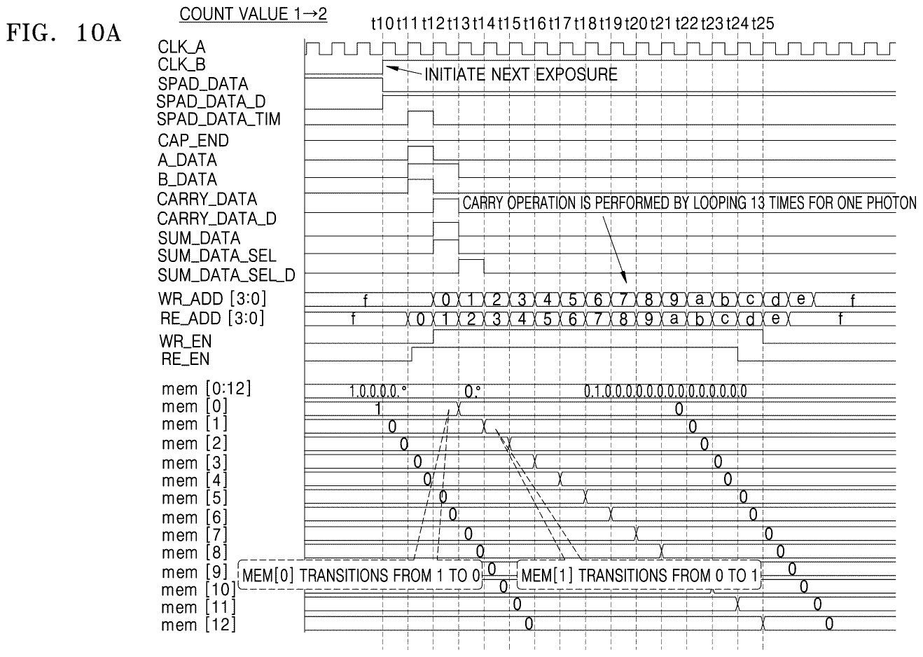

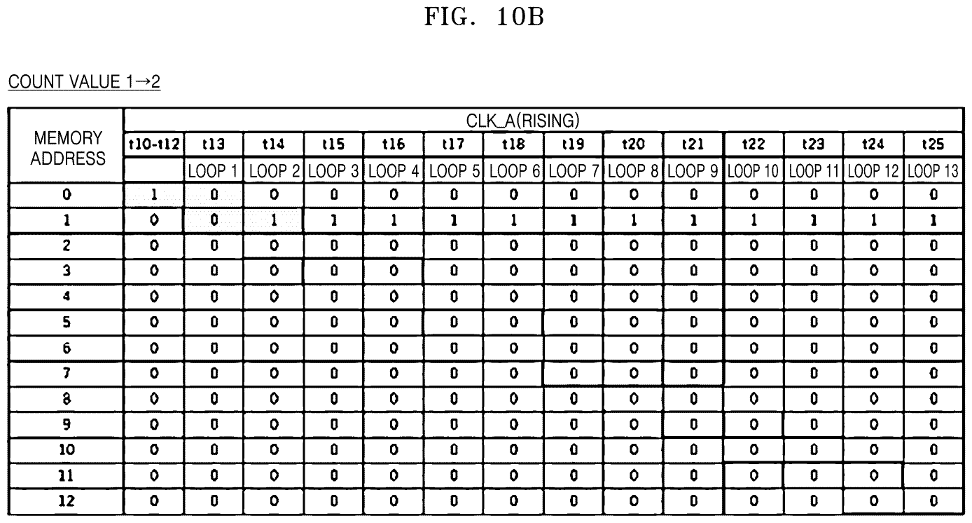

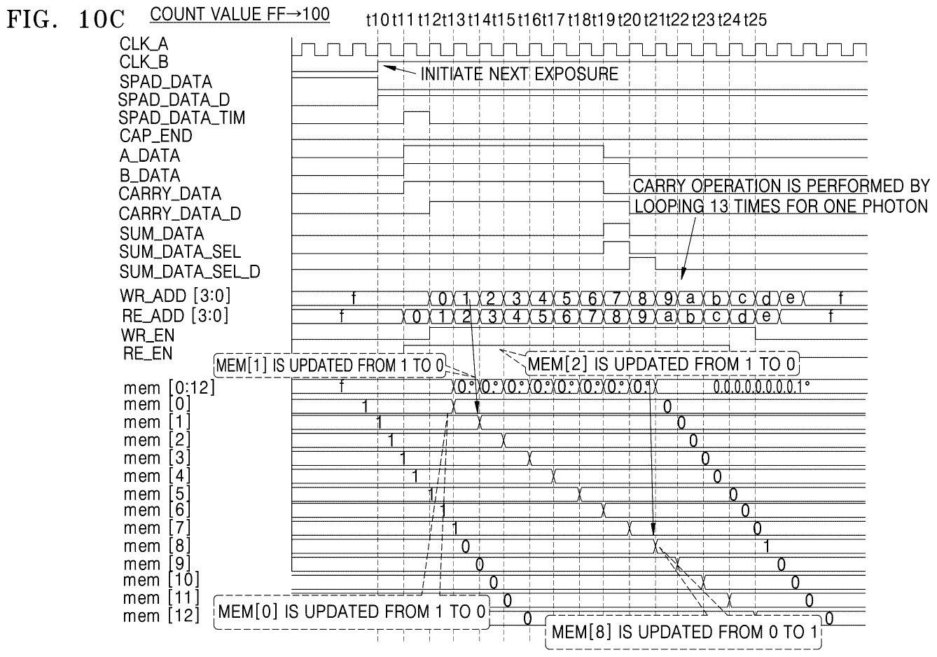

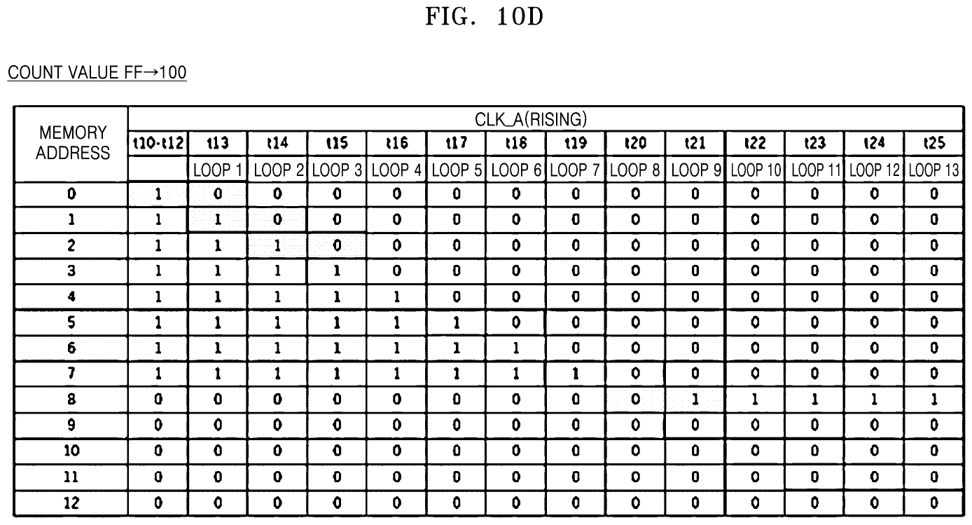

FIG. 9 is a time chart illustrating a timing of counting processing according to an embodiment. In the counting processing described below, the detection result of photons obtained from the previous exposure may be subjected to counting processing at the timing of the next exposure time. In SPAD_DATA_D, the detection result (SPAD_DATA) of photons (also referred to as the number of photons) may be added. The SPAD_DATA_TIM is a signal for processing the SPAD_DATA_D in accordance with the digit-increment timing. A region surrounded by the central dashed line in FIG. 9 corresponds to FIG. 10A.

(Change in Count Value from 0 to 1)

FIG. 10A is a time chart illustrating an example of counting processing during one exposure cycle, according to an embodiment. FIG. 10B is a table illustrating carry and addition processing performed a number of times corresponding to the number of bits, in correspondence with the time chart of FIG. 10A. In FIGS. 10A and 10B, the processing from p-1 to p of the number of exposure cycles (j) in the table of FIG. 8 is illustrated.

In FIG. 10A, time point t10 indicates the next exposure initiation timing. The exposure processing corresponds to operation S32 in FIG. 7. In FIG. 10A, CLK_A includes a signal having a period of 16 ns, and CLK_B includes a signal having a period of 2560 ns. The memory control circuit 320 may secure the address of each pixel 210 in the memory address of the SRAM 310. For example, in pixel 210_0, the memory control circuit 320 secures a number of addresses [0] to [12] corresponding to 13 counter bits. Addresses [0] to [12] respectively correspond to the first to thirteenth digits of the 13-digit binary counter.

WR_ADD includes an address for writing (hereinafter, referred to as a write address) on the SRAM 310 designated by the memory control circuit 320, and RE_ADD includes an address for reading (hereinafter, referred to as a read address) on the SRAM 310 designated by the memory control circuit 320. The memory control circuit 320 may sequentially shift the address designated in accordance with the timing of CLK_A. For example, at time point t13, the write address is designated as address [0], and the read address is designated as address [1]. At time point t14, the write address may be designated as address [1], and the read address may be designated as address [2]. At time point t10, count values accumulated up to the previous exposure cycle may be recorded in addresses [0] to [12]. That is, the count values at time point p-1 of the number of exposure cycles (j) in the table of FIG. 8 may be recorded in addresses [0] to [12], where “1” may be recorded in address [0] and “0” may be recorded in addresses [1] to [12].

As shown in FIGS. 10A and 10B, in loop 1 at time point t13, address [0] may be updated from 1 to 0 by addition processing performed by the one of the plurality of counter data generation circuits 212. In loop 2 at time point t14, address [1] may be updated from 0 to 1 by addition processing and carry processing performed by the one of the plurality of counter data generation circuits 212. In loops 3 to 13, from time point t15 to time point t25, the count values may be updated from 0 to 0 by addition processing and carry processing.

(Change in Count Value from FF to 100)

FIG. 10C is a time chart illustrating another example of counting processing during one exposure cycle, according to an embodiment. FIG. 10D is a table illustrating carry and addition processing performed a number of times corresponding to the number of bits, in correspondence with the time chart of FIG. 10C, according to an embodiment. In FIGS. 10C and 10D, the processing from q-1 to q of the number of exposure cycles (j) in the table of FIG. 8 is illustrated.

In FIG. 10C, time point t10 indicates the next exposure initiation timing. At time point t10, the count values accumulated up to the previous exposure cycle may be recorded in addresses [0] to [12]. That is, the count values at the time point q-1 of the number of exposure cycles (j) in the table of FIG. 8 may be recorded in addresses [0] to [12], where “1” may be recorded in addresses [0] to [7] and “0” may be recorded in addresses [8] to [12].

As shown in FIGS. 10C and 10D, when a photon is received during the previous exposure cycle, in loop 1 at time point t13, address [0] may be updated from 1 to 0 by addition processing performed by the one of the plurality of counter data generation circuits 212. In loop 2 at time point t14, address [1] may be updated from 1 to 0 by addition processing and carry processing performed by the one of the plurality of counter data generation circuits 212. In loop 3 at time point t15, address [2] may be updated from 1 to 0 by addition processing and carry processing performed by the one of the plurality of counter data generation circuits 212. Similarly, from time point t16 to time point t20, addresses [3] to [7] may be updated from 1 to 0 by addition processing and carry processing. In loop 9 at time point t21, address [8] may be updated from 0 to 1 by addition processing and carry processing performed by the one of the plurality of counter data generation circuits 212. During loops 10 to 13 from time point t22 to time point t25, the count values may be updated from 0 to 0 by addition processing and carry processing.

Through the processing described above, the exposure processing and counting processing may be repeated until the processing of loop B shown in FIG. 7 is completed and the number of repetitions (j) reaches m (=8192).

### (Operations S4 and S5)

As shown in FIG. 6, the controller 500 may read an image signal (count value) from the memory address assigned to each of the plurality of pixels 210 and may generate image data from the exposure time and the count value set in operation S2.

### (Operation S6)

When imaging for the next frame is to be performed, the processing from operation S2 onward is repeated. When imaging of the next frame is not performed, the processing may be terminated (End).

### (Exposure-Time Setting Processing Based on Illuminance Determination)

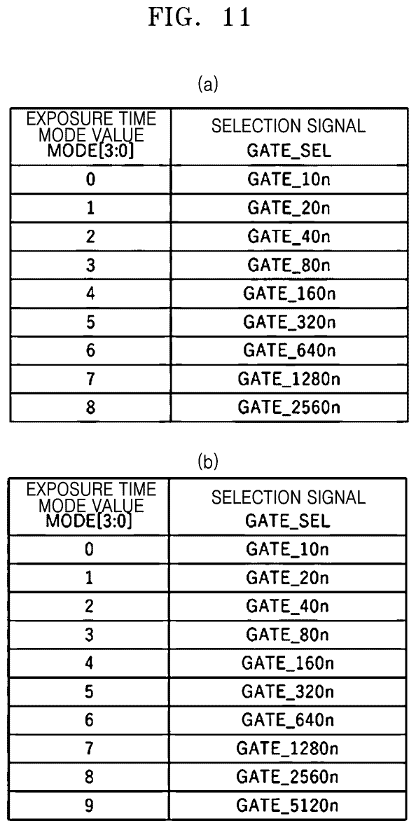

Hereinafter, the exposure-time setting processing for each pixel based on illuminance determination is described with reference to FIGS. 11 to 16. FIG. 11 is a table illustrating an example of an exposure-time setting range according to an embodiment. This table may be used by a mode selection circuit described below. FIG. 11A is a table illustrating an exposure-time setting range in a first example. As shown in FIG. 11A, exposure times of 10 ns, 20 ns, 40 ns, 80 ns, 160 ns, 320 ns, 640 ns, 1280 ns, and 2560 ns may be sequentially selected in 9 steps from mode 0 to mode 8. FIG. 11B is a table illustrating an exposure-time setting range in a second example. In the second example, a step of 5120 ns in mode 9 is added, compared to the first example. For example, the first example may be used for capturing general videos, while the second example may be used for capturing security videos that require high-sensitivity imaging even at a low frame rate. Hereinafter, a case where the first example of FIG. 11A is used is described as an example.

FIG. 12 is a schematic diagram of the illuminance determination circuit 410 and the plurality of exposure control circuits 420 according to an embodiment. Each one of the plurality of exposure control circuits 420 may be included in each one of the plurality of pixels 210. The illuminance determination circuit 410 may be configured to be shared by the plurality of pixels 210. By sharing the illuminance determination circuit 410, the circuit scale may be reduced.

In FIG. 12, the illuminance determination circuit 410 may be shared by 48 pixels from pixel 210_0 to pixel 210_47. However, FIG. 12 is merely an example. The number of shared pixels is not limited to 48. The illuminance determination circuit 410 may be shared by various numbers of the plurality of pixels 210, according to an embodiment.

A multiplexer m3 may sequentially switch and acquire the count values of pixels 210_0 to 210_47 and maintain the same in the lower flip-flop. In an embodiment, the maintained count values are sequentially transmitted to a determination circuit 411 according to a signal of CLK_A, but are not limited thereto. A clock independent of CLK_A may be used.

The determination circuit 411 may set an addition value (ADD_DATA) (hereinafter, also referred to as ADD) in a range of “−2” to “+7”, according to the count value of the pixel 210 in the previous frame (see FIG. 12). The set ADD may be transmitted to the exposure control circuit 420 of each pixel 210.

When exposure is initiated, mode 0 (see FIG. 11A) may be selected as an initial value in each of the plurality of exposure control circuit 420s of each of the plurality of pixels 210. The determination circuit 411 may add the set ADD for the current mode. When the addition result is 8 or more, an upper limit of 8 may be set, and when the addition result is 0 or less, a lower limit of 0 may be set.

The one of the plurality of exposure control circuits 420 may transmit a selection signal (GATE_SEL) of an exposure time selected from among a plurality of exposure-time signals generated by the exposure signal generation circuit 430 to the one of the plurality of SPADs 211. The one of the plurality of SPADs 211 may perform exposure at the selected exposure time.

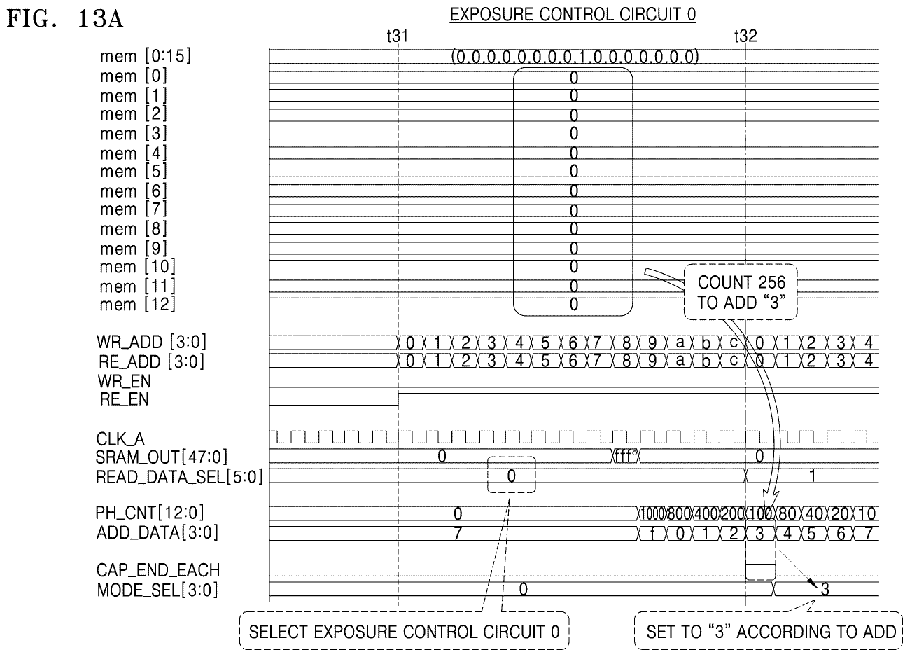

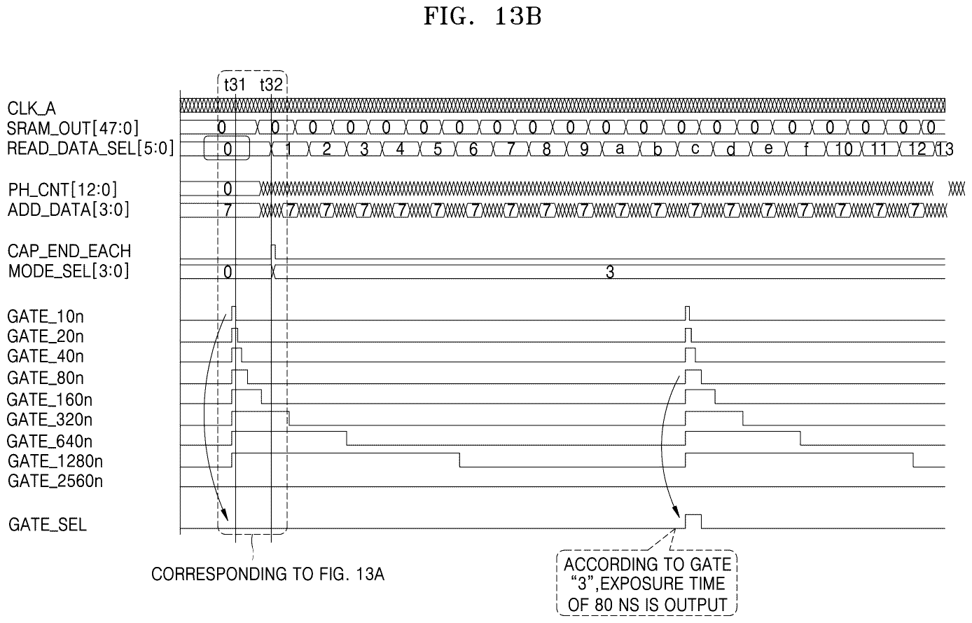

FIG. 13A is a time chart illustrating exposure-time setting processing of the illuminance determination circuit 410 and an exposure control circuit 0, (where the exposure control circuit 0 includes the one of the plurality of exposure control circuits 420 for pixel 210_0 and the same applies hereinafter), according to an embodiment. As shown in FIG. 13A, the determination circuit 411 of the illuminance determination circuit 410 may determine ADD as “+3” from the count value “256” in the current frame (see the table in FIG. 12). The exposure control circuit 0 for pixel 210_0 changes MODE_SEL (hereinafter referred to as MODE) from “0” to “3” at the timing of time point t32, according to ADD. In addition, the notation “off*” in FIGS. 13A, 14A, and 15A represents a number having twelve “f” in hexadecimal, that is, a value having forty-eight “1” in binary. In addition, in FIG. 13A, the numerical value of PH_CNT [12:0] is written in hexadecimal. For example, [100] corresponds to 256 in decimal as shown in the table of the determination circuit 411 in FIG. 12, and [1000] likewise corresponds to 4096 in decimal.

FIG. 13B illustrates a compressed time scale of the horizontal axis of FIG. 13A, according to an embodiment. In the following exposure cycle, the exposure control circuit 0 may expose the one of the plurality of SPADs 211 for an exposure time of 80 ns according to the set MODE “3” (see FIG. 11A).

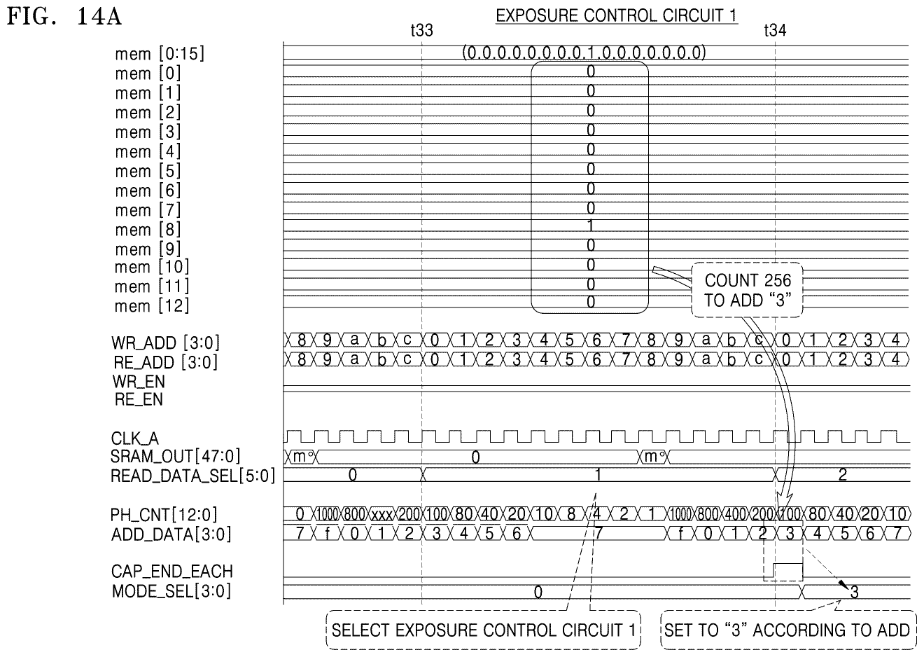

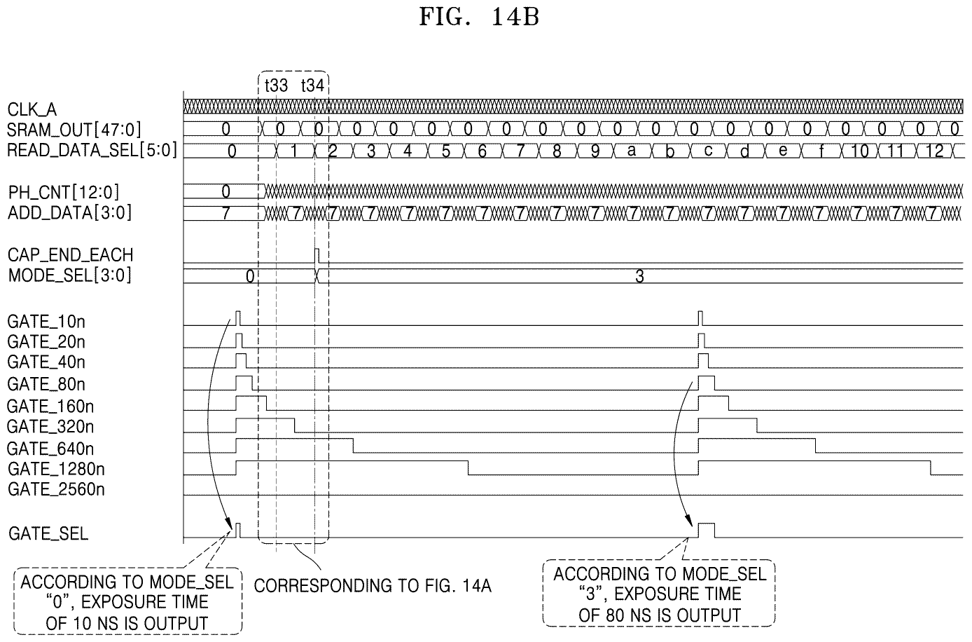

FIG. 14A is a time chart illustrating exposure-time setting processing of the illuminance determination circuit 410 and an exposure control circuit 1, according to an embodiment. As shown in FIG. 14A, the determination circuit 411 of the illuminance determination circuit 410 may determine ADD as “+3” from the count value “256” in the current frame. The exposure control circuit 1 for pixel 210_1 may change MODE “0” to MODE “3” at the timing of time point t34, according to ADD.

FIG. 14B illustrates a compressed time scale of the horizontal axis of FIG. 14A, according to an embodiment. In the following exposure cycle, the exposure control circuit 1 may expose the one of the plurality of SPADs 211 for the exposure time of 80 ns according to the set MODE “3”.

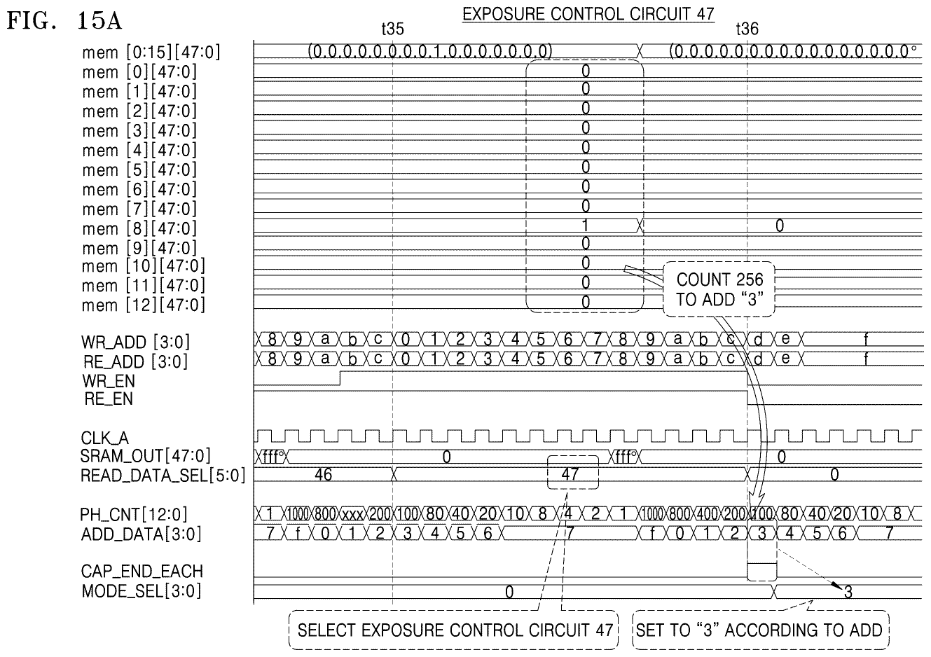

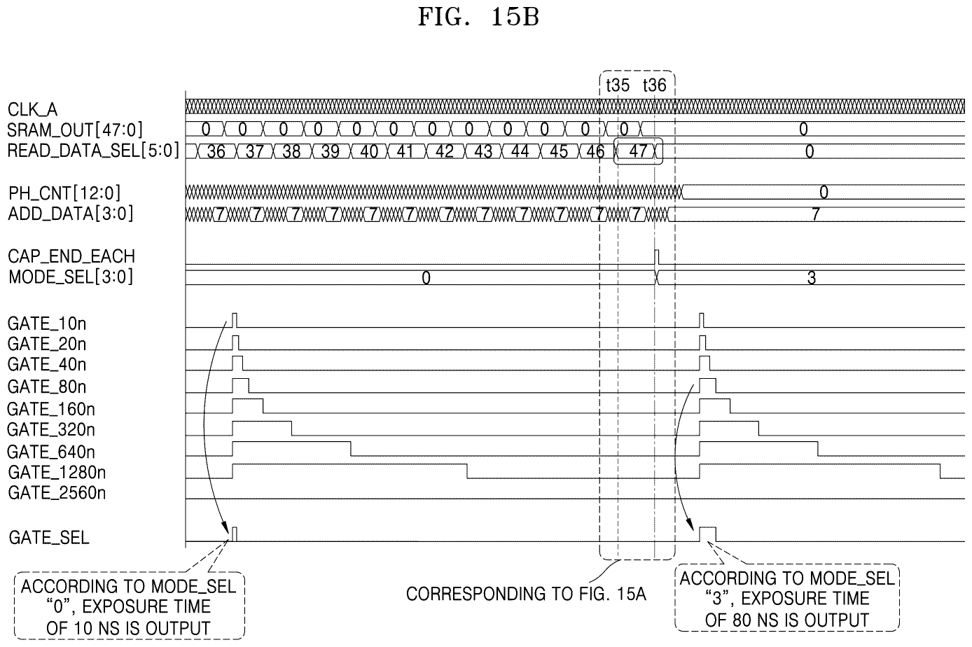

FIG. 15A is a time chart illustrating exposure-time setting processing of the illuminance determination circuit 410 and an exposure control circuit 47, according to an embodiment. As shown in FIG. 15A, the determination circuit 411 of the illuminance determination circuit 410 may determine ADD as “+3” from the count value “256” in the current frame. The exposure control circuit 47 for pixel 210_47 may change MODE “0” to MODE “3”at the timing of time point t36 according to ADD.

FIG. 15B illustrates a compressed time scale of the horizontal axis of FIG. 15A according to an embodiment. In the following exposure cycle, the exposure control circuit 47 may expose the one of the plurality of SPADS 211 for the exposure time of 80 ns according to the set MODE “3”. In this embodiment, although the count values of all pixels are the same (e.g., 256), it is assumed that, in practice, the count values may be different from each other.

As such, the illuminance determination circuit 410 shared by pixels 210_0 to 210_47 may sequentially determine the illuminance of pixels 210_0 to 210_47 in one frame and store and maintain the determination results as ADD. In the next frame, the exposure time for each pixel may be set using the ADD for that pixel (selection of GATE). As such, the optimal exposure time may be dynamically set for each pixel, and the circuit scale may be reduced by sharing the illuminance determination circuit 410 among the plurality of pixels 210 to enable exposure-time setting for each pixel.

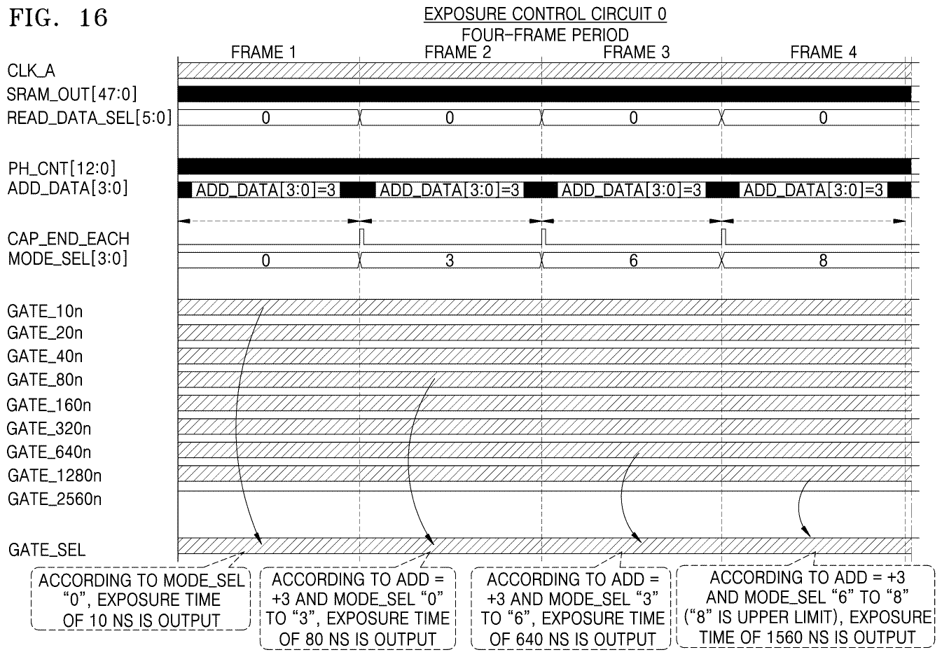

FIG. 16 is a time chart illustrating exposure-time setting processing of the illuminance determination circuit 410 and the exposure control circuit 0 across multiple frames, according to an embodiment. In FIG. 16, an operation in a case where illuminance from an imaging target rapidly decreases from frame 1 to frame 4 is shown. In frame 1, MODE “0” is set, and accordingly, an exposure time of 10 ns is output.

In frame 2, since the count value for the exposure time of 10 ns in frame 1 is less than an appropriate range (2048 to 4095) (i.e., because the amount of exposure is insufficient), MODE “3” is set by the mode selection circuit 421 according to the determination of ADD “3” by the determination circuit 411, and accordingly, an exposure time of 80 ns is output.

In frame 3, since the count value for the exposure time of 80 ns in frame 2 is small (i.e., because the amount of exposure is insufficient), MODE “6” is set by the mode selection circuit 421 according to the determination of ADD “3” by the determination circuit 411, and accordingly, an exposure time of 640 ns is output.

In frame 4, since the count value is small even for the exposure time of 640 ns in frame 3 (i.e., because the amount of exposure is insufficient), MODE “8” is set by the mode selection circuit 421 according to the determination of ADD “3” by the determination circuit 411, and accordingly, a maximum exposure time of 2560 ns is output. In addition, although ADD “3” is determined even in frame 4, “3” may not be added to “6” because MODE “8” is the upper limit (see FIG. 11A), and thus MODE “8” is set.

As such, the solid-state imaging device in the first embodiment may include a plurality of pixels and a counter unit, wherein each of the plurality of pixels includes an SPAD, and the counter unit includes a memory unit and a counter data generation circuit corresponding to the SPAD. The memory unit may also include a counter (a region of the memory address) corresponding to each pixel. The counter data generation circuit may perform addition processing that sequentially performs carry addition for each designated digit during counting of the number of photons incident on the SPAD, and recording processing that sequentially records the addition result in the counter for each designated digit. In addition, each counter data generation circuit may be connected to the memory unit with a single wire corresponding to the designated digit (e.g., 1 digit). Additionally, the addition processing may refer to processing that adds bit data of the designated digit of the counter and carry bit data corresponding to the designated digit during the counting, based on address control by the memory control circuit. The recording processing may refer to processing that records the addition result from the addition processing in the designated digit of the counter, based on address control by the memory control circuit.

Thus, by placing components other than part of the counter function outside the pixel region, the circuit scale placed in the pixel region during imaging may be reduced, and thus higher resolution may be achieved.

### (Variation 1)

Next, a configuration where the number of connection wires between the one of the plurality of counter data generation circuits 212 and the SRAM 310 is changed, and a memory map of the counter within the SRAM 310 are described below. The 13-bit counter is described as an example in the first embodiment, but hereinafter, a 16-bit counter is described below. In addition, the counters of the SRAM 310 corresponding to pixels 210_0 to 210_47 of the plurality of pixels 210, which represent 48 pixels in total (=8 pixels horizontally×6 pixels vertically), are described herein.

### First Embodiment: 1-bit Connection

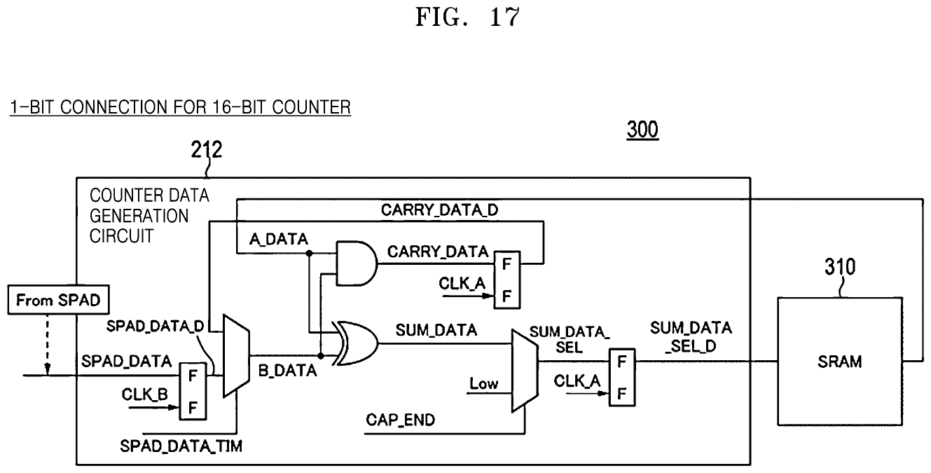

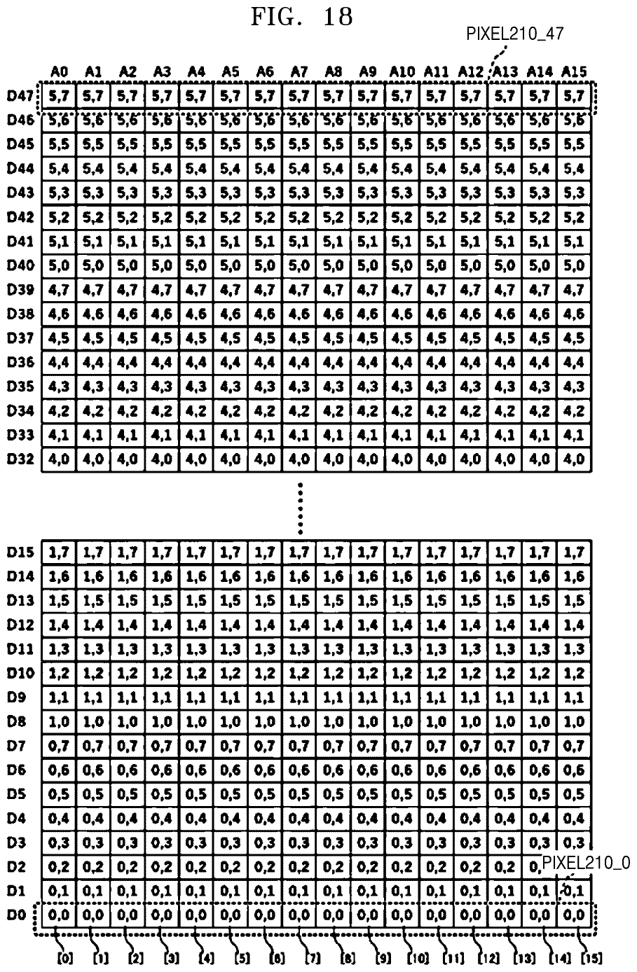

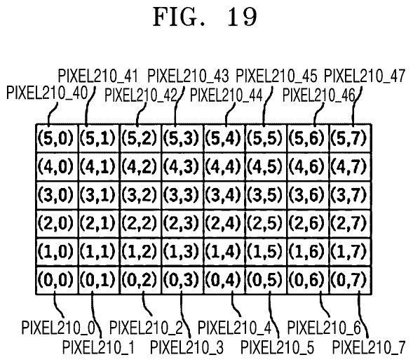

FIG. 17 is a schematic diagram of one of the one of the plurality of counter data generation circuits 212 for 1-bit connection according to an embodiment. FIG. 18 is a diagram illustrating an example of a memory map of the 16-bit counter within the SRAM 310 in the connection configuration of FIG. 17, according to an embodiment. FIG. 19 is a table illustrating an example of mapping between each pixel and the memory map of FIG. 18 and illustrating the X and Y coordinates of each pixel in a pixel array, according to an embodiment. In addition, FIG. 17 may be the same diagram as FIG. 3 in the first embodiment described above. FIG. 18 illustrates a memory map in a two-dimensional array, where the X-axis and the Y-axis represent addresses of the array, and the coordinates (0,0) to (5,7) within the table may respectively correspond to 48 pixels (=8 pixels horizontally×6 pixels vertically). For example, referring to FIG. 19, the notation “(0,0)” in the memory map of FIG. 18 denotes the counter of pixel 210_0 corresponding to the coordinates (0,0) in the pixel array 200, and the notation (5,7) in the memory map of FIG. 18 denotes the counter of pixel 210_47 corresponding to the coordinates (5,7) in the pixel array 200. In addition, FIG. 19 may also be commonly applied to each variation described below.

As shown in FIG. 18, 16-bit counters [0] to [15] of pixel 210_0 may be sequentially assigned to the address region of arrays (D0,A0) to (D0,A15). Additionally, addresses [0] to [15] corresponding to the 16-bit counter of pixel 210_47 may be sequentially assigned to the address region of arrays (D47,A0) to (D47,A15). Using the 16-bit address region assigned to each of the plurality of pixels 210, the one of the plurality of counter data generation circuits 212 may perform addition processing that sequentially performs carry addition for each designated digit (for each single digit in this embodiment) during counting of the number of photons in the SPAD, and recording processing that sequentially records the addition result to the address region for each designated digit (for each single digit in this embodiment).

(Variation 1-1: 2-bit Connection)

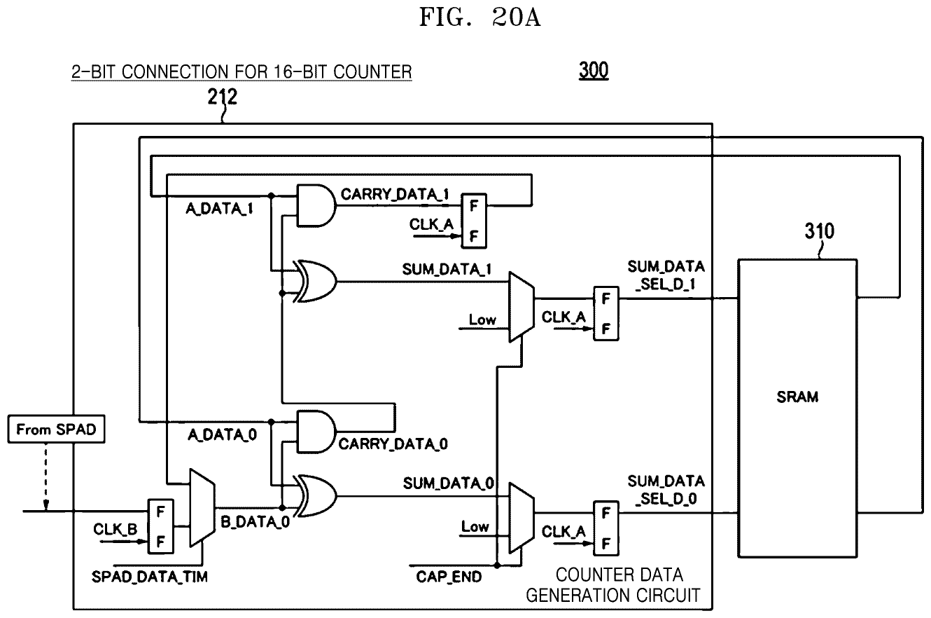

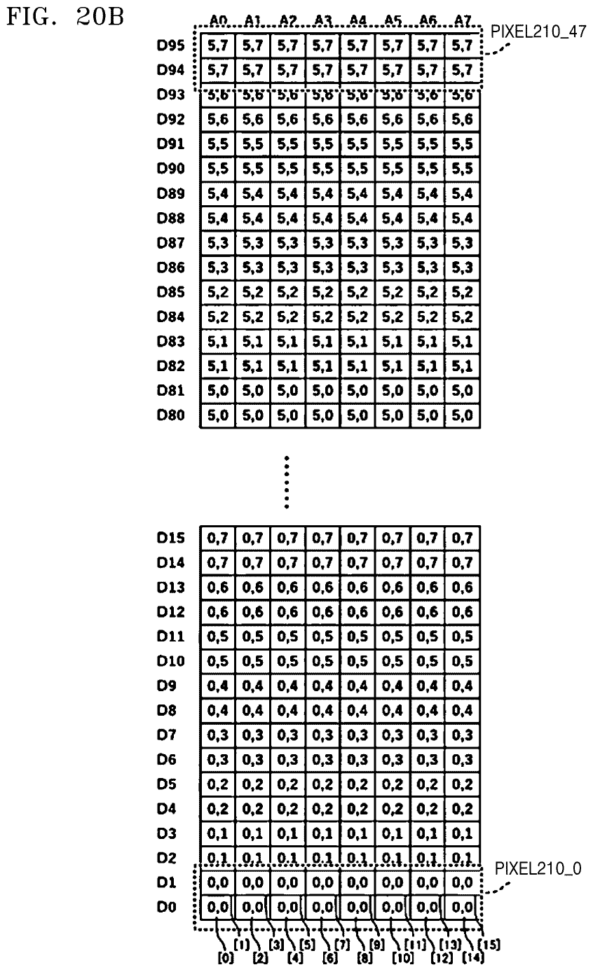

FIG. 20A is a schematic diagram of one of the plurality of the counter data generation circuits 212 for 2-bit connection according to an embodiment. FIG. 20B is a diagram illustrating an example of a memory map of the 16-bit counter within the SRAM 310 in the connection configuration of FIG. 20A, according to an embodiment. For 2-bit connection, addition processing may be performed in 2-bit units and recording processing for addition results may be performed in 2-bit units.

As shown in FIGS. 20B, 16-bit counters [0] to [15] of pixel 210_0 may be sequentially assigned to the address region of arrays (D0,A0) to (D1,A7). For example, the addition results of the lowest 1-bit and 2-bit may be recorded in arrays (D0,A0) and (D1,A0), respectively. In addition, the 16-bit counters [0] to [15] of pixel 210_47 may be sequentially assigned to the address region of arrays (D94,A0) to (D95,A7).

(Variation 1-2: 4-bit Connection)

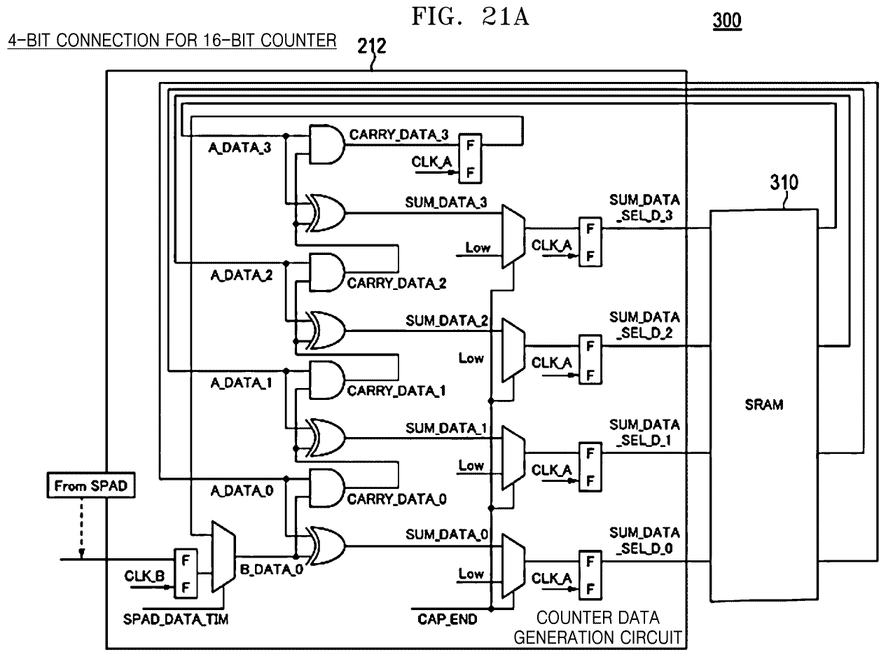

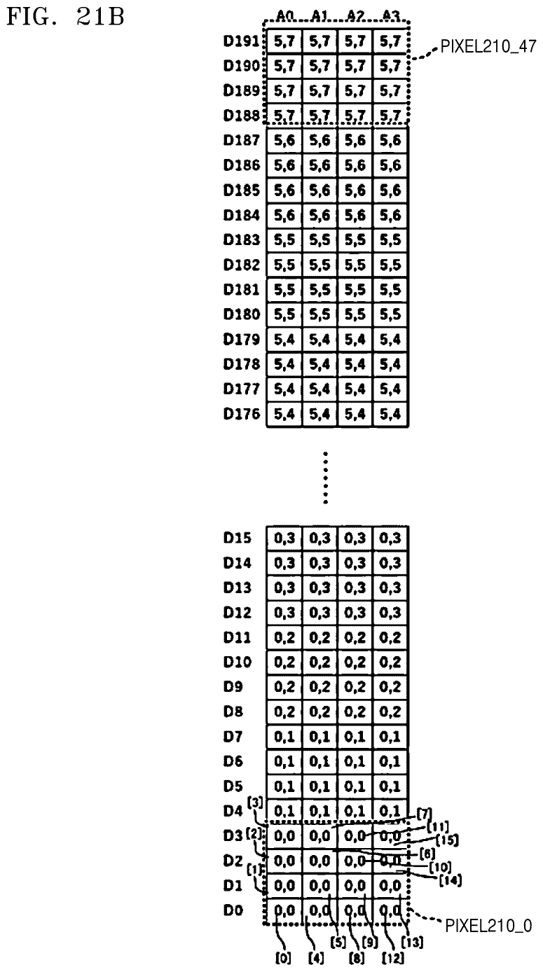

FIG. 21A is a schematic diagram of one of the plurality of the counter data generation circuit 212 for 4-bit connection, according to an embodiment. FIG. 21B is a diagram illustrating an example of a memory map of the 16-bit counter within the SRAM 310 in the connection configuration of FIG. 21A, according to an embodiment. In 4-bit connection, addition processing is performed in 4-bit units, and recording processing for the addition results is performed in 4-bit units.

As shown in FIG. 21B, the 16-bit counters [0] to [15] of pixel 210_0 may be sequentially assigned to the address region of arrays (D0,A0) to (D3,A3). The 16-bit counters to [15] of pixel 210_47 are sequentially assigned to the address region of arrays (D188,A0) to (D191,A3).

(Variation 1-3: 8-bit Connection)

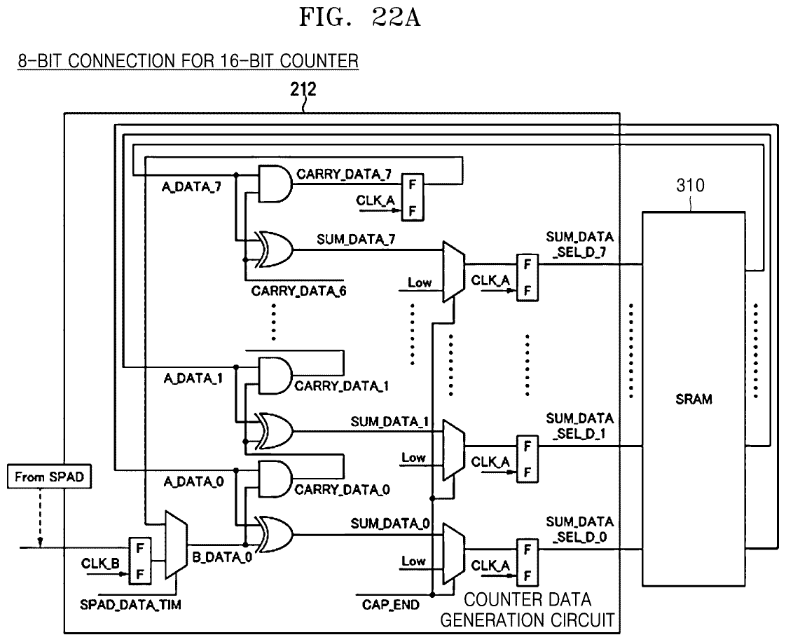

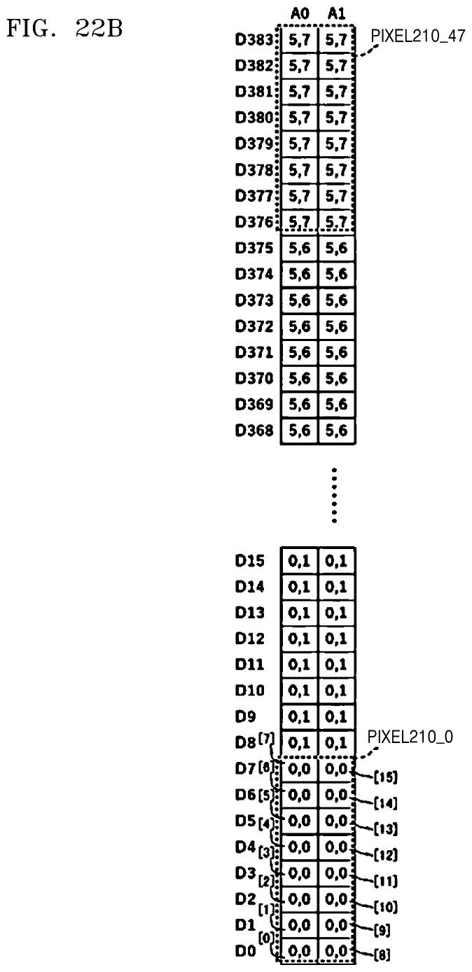

FIG. 22A is a schematic diagram of one of the plurality of the counter data generation circuits 212 for 8-bit connection according to an embodiment. FIG. 22B is a diagram illustrating an example of a memory map of the 16-bit counter within the SRAM 310 in the connection configuration of FIG. 22A, according to an embodiment. In 8-bit connection, addition processing is performed in 8-bit units, and recording processing for the addition results is performed in 8-bit units.

As shown in FIGS. 22B, 16-bit counters [0] to [15] of pixel 210_0 are sequentially assigned to the address region of arrays (D0,A0) to (D7,A1). Additionally, 16-bit counters [0] to [15] of pixel 210_47 may be sequentially assigned to the address region of arrays (D376, A0) to (D383, A1).

As such, each of the plurality of counter data generation circuits 212 is connected to the memory unit (e.g., SRAM 310) by the wire corresponding to the designated bit, and FIGS. 17 to 22B illustrate, for example, 1-bit connection, 2-bit connection, 4-bit connection, and 8-bit connection. However, the number of connection wires between the plurality of counter data generation circuits 212 and the memory unit is not limited thereto. The number of connection wires between the plurality of counter data generation circuits 212 and the memory unit, according to an embodiment, may be 3, 5, 7, and the like. In addition, the number of connection wires may not necessarily be a divisor of the number of bits. For example, when the counter of each of the plurality of pixels 210 is 13 bits as shown in the first embodiment, the connection between one of the plurality of the counter data generation circuits 212 and the memory unit may include 2-bit connection, 4-bit connection, and the like. For example, for the 2-bit connection, 16 or 14 addresses may be assigned to be evenly divisible, and the first to thirteenth addresses may be used for reading and recording during the counter processing, while subsequent addresses, such as the fourteenth address, may not be used or may be used for dummy recording processing.

### (Equalization of Counter Processing)

In the first embodiment, when addition processing and recording processing using the counter of the SRAM 310 are performed during the counting processing cycle of CLK_A, it is assumed that CLK_A has a period of 16 ns.

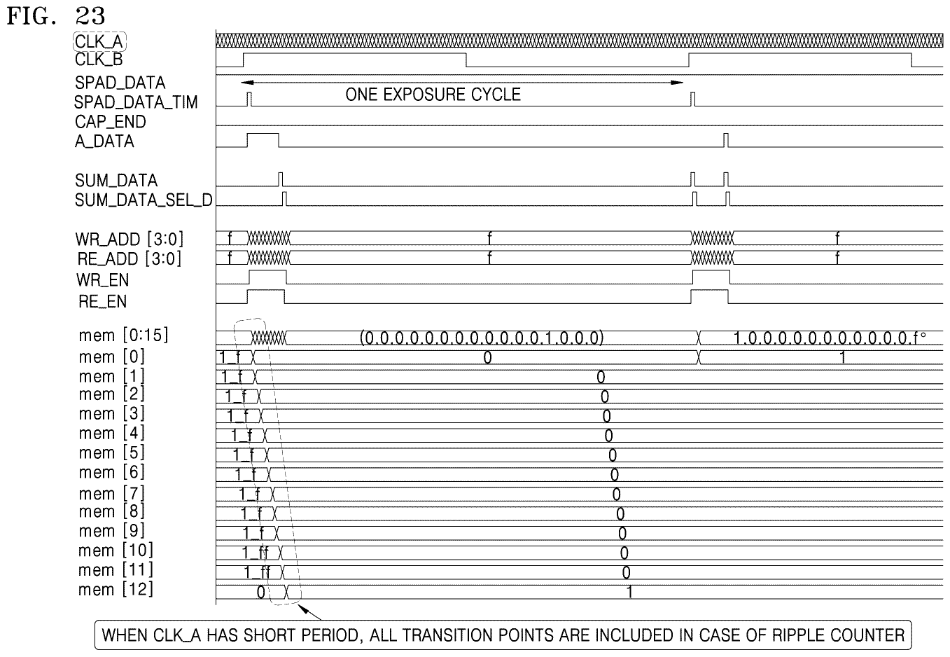

FIG. 23 is a timing chart illustrating the timing of counter processing of the first embodiment, according to an embodiment. Since CLK_A has a short period, the recording processing timing of counters [0] to [12] of the SRAM 310 may be concentrated within a short period, as in the case of using the counter unit 300, which is a ripple-counter type.

### (Variation 2)

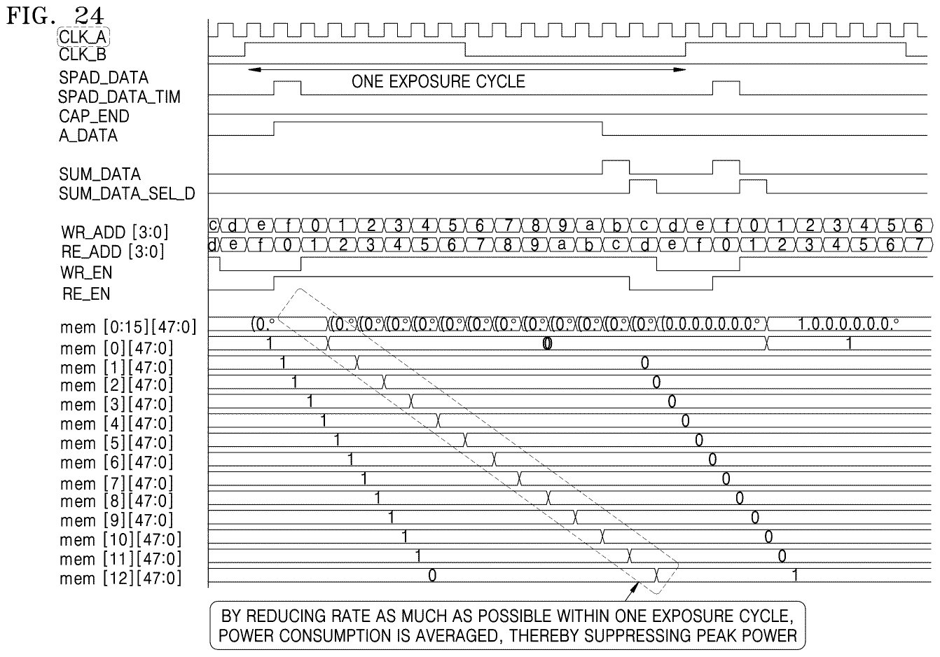

FIG. 24 is a timing chart illustrating the timing of counter processing of variation 2, according to an embodiment. In the case of variation 2, CLK_A may be set to have a long period. Specifically, it may be preferable to set CLK_A as long as possible within a range that allows counter processing corresponding to the number of counter bits to be included in one exposure cycle. For example, CLK_A is set to a period close to 2560 ns/13 times. By lowering and equalizing the rate as much as possible within one exposure cycle to perform the counter processing, the power consumption may be equalized and the peak current value may be suppressed.

### (Variation 3)

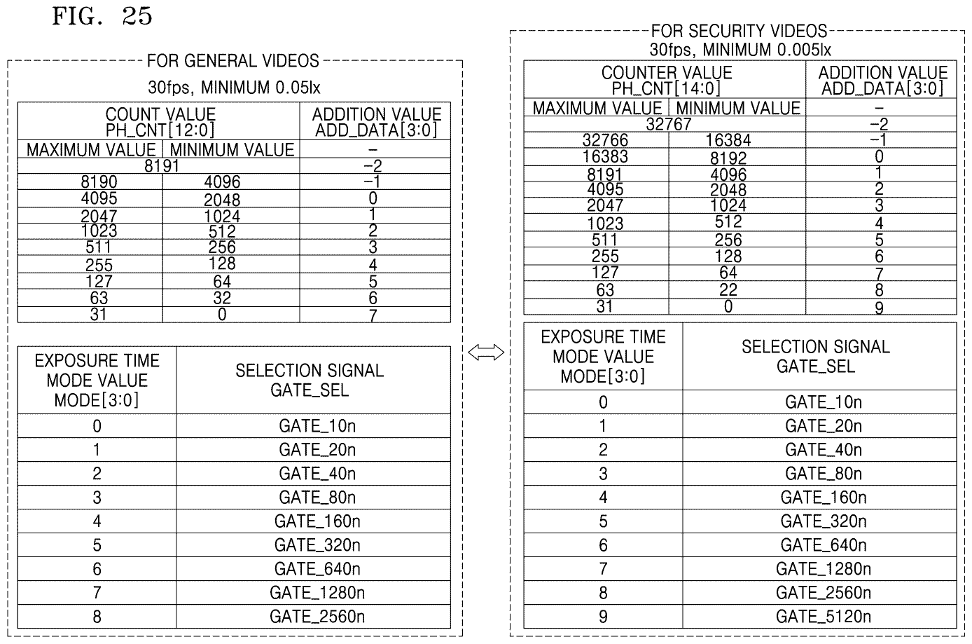

FIG. 25 is a table illustrating variation 3 according to an embodiment. In the first embodiment, a case where the number of counter bits, the exposure-time setting range, and the illuminance determination circuit 410 are fixed conditions is described. In variation 3, these components are configured to be variable. For example, by inputting a selection instruction to the controller 500 from the outside, the conditions for general videos and for security videos used for surveillance or monitoring may be switched with each other. The table shown in FIG. 25 includes a table showing the exposure-time setting range described with reference to FIGS. 11 and 12 and an ADD determination table used in the determination circuit 411 of the illuminance determination circuit 410. For example, under conditions for general videos, a 13-bit counter may be used at 30 fps with an exposure time range of about 10 ns to about 2560 ns, and under conditions for security videos, a 14-bit counter may be used at 3 fps with an exposure time range of about 10 ns to about 5120 ns. This conversion may also allow adjustment of the tracking method when the brightness changes. By configuring the exposure time range and the illuminance determination circuit 410 to be variable, the tracking method may be adjusted when the brightness changes.

### Second Embodiment

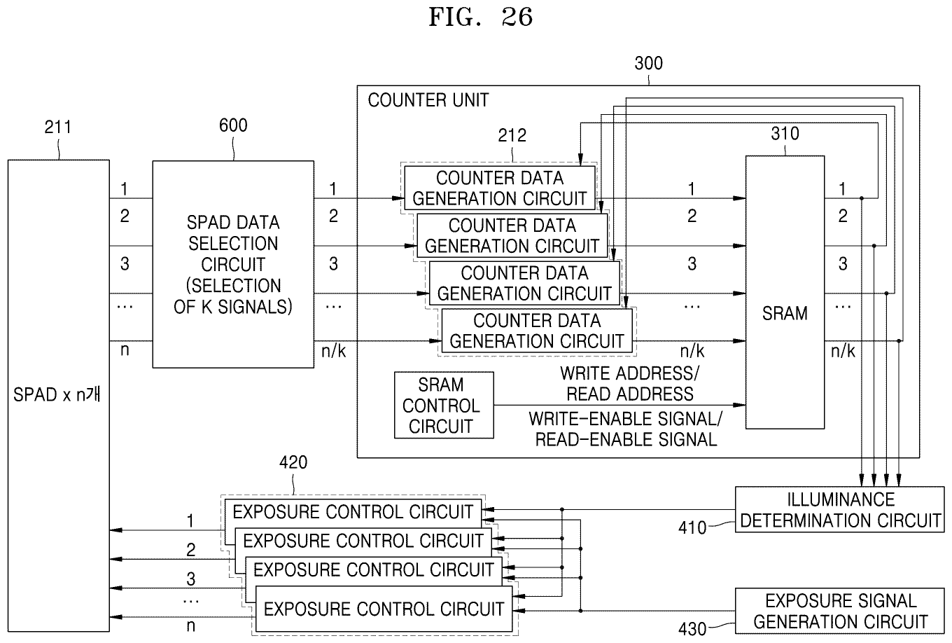

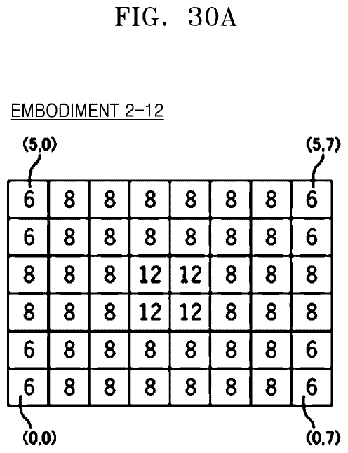

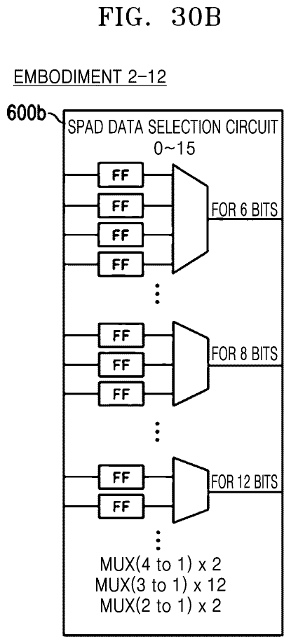

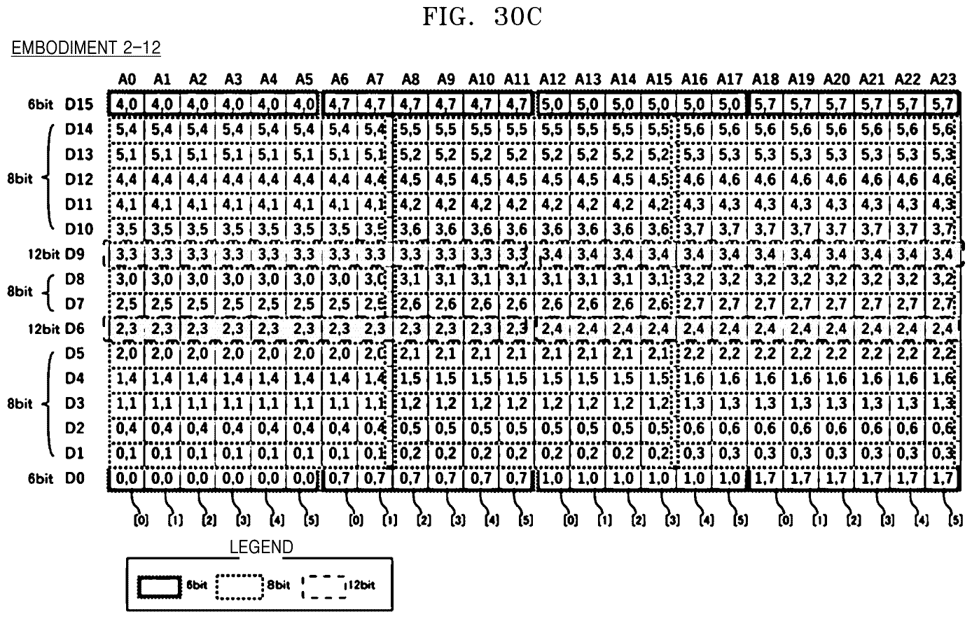

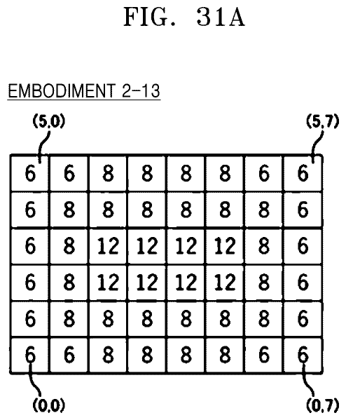

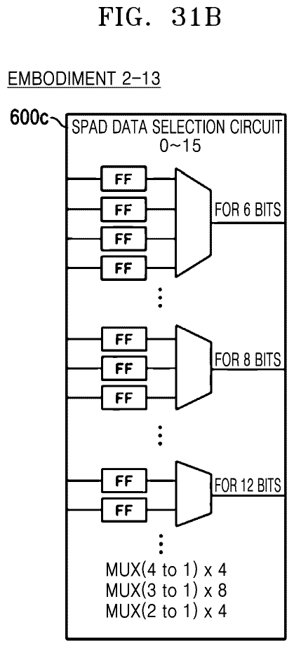

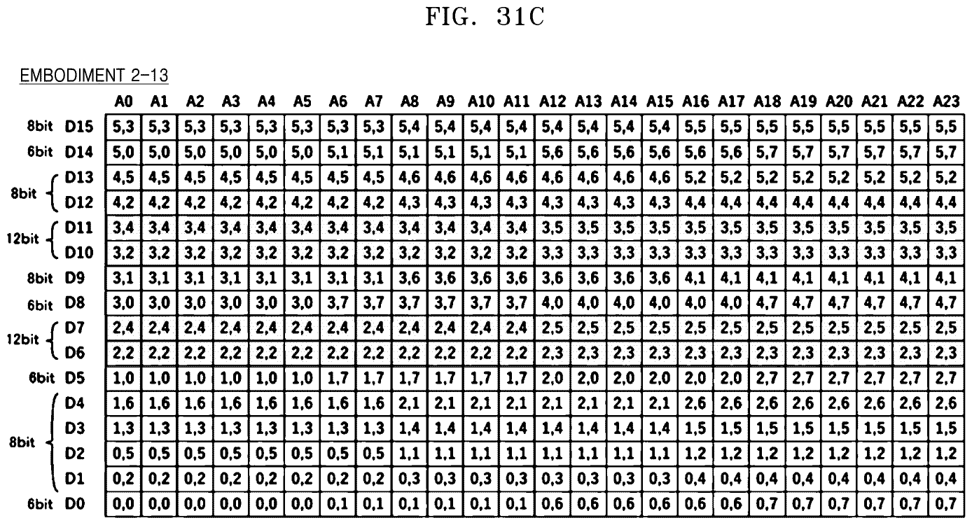

Next, the solid-state imaging device 100 according to a second embodiment is described with reference to FIGS. 26 to 29C. In the second embodiment, by using the SPAD data selection circuit 600, the number of counter bits of the plurality of pixels 210 may be configured to be variable when using the counter region of the same bit width and bit length in the SRAM 310. Therefore, the dynamic range of some of the plurality of pixels 210 may be selectively enhanced. For example, in a pixel block (described below with reference to FIGS. 30A and 31A) including the plurality of pixels 210, the dynamic range of central pixels of the plurality of pixels 210 may be increased by assigning more memory resources to the central pixels 210 than to peripheral pixels of the plurality of pixels 210.

FIG. 26 is a schematic diagram of the solid-state imaging device 100 including an SPAD data selection circuit 600 of the second embodiment, according to an embodiment. The SPAD data selection circuit 600 may select k SPADs from among n SPADs, sequentially perform carry addition for each designated digit by one of the plurality of the counter data generation circuits 212 and the SRAM 310 within the data counter unit 300 with respect to the signal outputs of the k SPADs, and sequentially record the addition result in the address region for each designated digit. Preferably, n is a multiple of k, and the same selection may be sequentially performed to perform counting processing for n SPADs. The SPAD data selection circuit 600 may correspond to an SPAD data selection unit, and specifically may be configured with n/k multiplexer circuits.

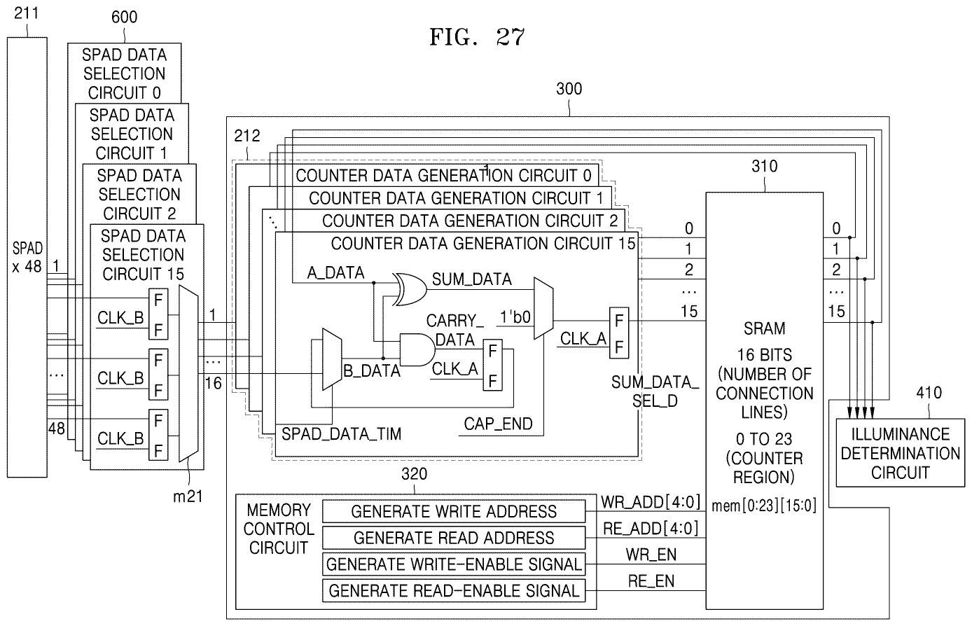

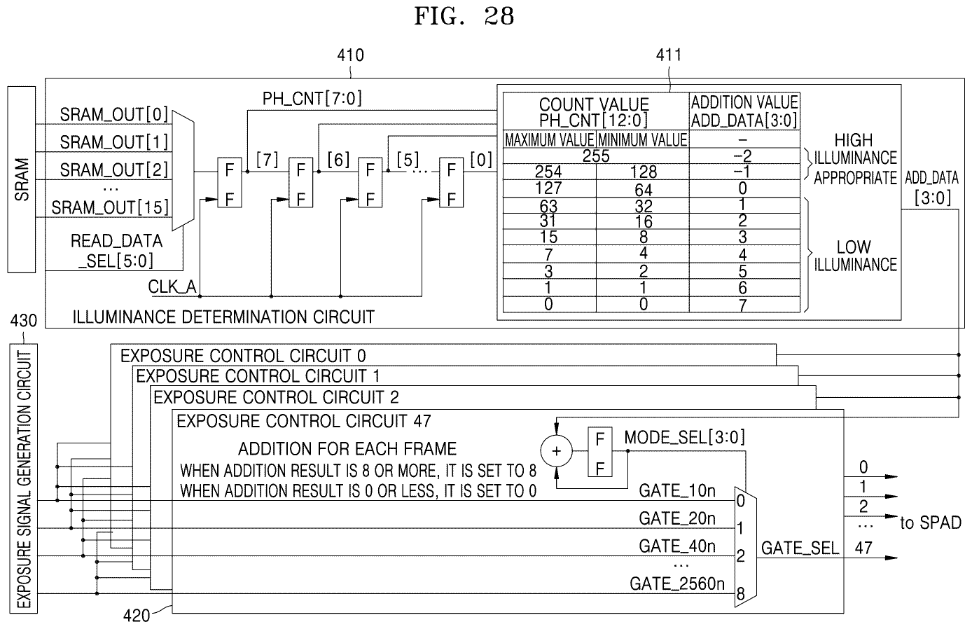

FIG. 27 is a schematic diagram of the SPAD data selection circuit 600 and the counter unit 300 according to an embodiment. The SPAD data selection circuit 600 may include 16 multiplexer circuits (e.g., k=3). Since the configuration of the counter unit 300 performs the same processing as in the first embodiment, the description thereof is omitted. FIG. 28 is a schematic diagram of the illuminance determination circuit 410 and the plurality of exposure control circuits 420 according to an embodiment. In FIGS. 27 and 28, as in the first embodiment described above, the configuration of the counter unit 300 is shown for 48 pixels 210 (=8 pixels horizontally×6 pixels vertically) of the pixel array 200. In addition, the description is given according to the following specifications. In addition, the number 48 is merely an example. In most cases, the number 48 may be greater than that in this embodiment. In the second embodiment shown in FIGS. 26 to 28 and FIGS. 29A to 29C, the specifications in the initial state (embodiment 2-11 of the second embodiment) are as follows:
(Specifications of SRAM 310)
Bit width (number of connection wires): 16 bits,
Bit length (counter region): 24 bits.
(SPAD Data Selection Circuit 600)
Number of SPAD data selection circuits (multiplexer circuits): 16,
Number of SPADs assigned to each SPAD data selection circuit (number of assigned pixels (k)): 3,
Number of counter bits of SPAD: 8 bits, 8 bits, 8 bits,
Sum of bits of SPADs assigned to each SPAD data selection circuit (sum of assigned bits (sb)): 24 bits.

As such, by designing the number of bit widths of the SRAM 310 to be equal to the number of SPAD data selection circuits (multiplexer circuits), the counting processing of the SRAM 310 may be efficiently performed for each bit width.

As shown in the above specification, 3 of the plurality of SPADs 211 (i.e., 3 pixels 210) each having a designated bit length of 8 bits may be assigned to each SPAD data selection circuit 600. Additionally, first to sixteenth SPAD data selection circuits 600_0 to 600_15 may be provided corresponding to a total of 48 SPADs 211. Each of the plurality of pixels 210 may include one of the plurality of SPADs 211, but is not limited thereto. According to an embodiment, one of the plurality of pixels 210 may include multiple ones of the plurality of SPADs 211. A multiplexer m21 of each of the first to sixteenth SPAD data selection circuits 600_0 to 600_15 may sequentially switch photon detection results of 3 pixels among pixels 210_0 to 210_47 and transmit the same to the lower one of the plurality of counter data generation circuits 212. For example, the multiplexer m21 of the sixteenth SPAD data selection circuit 600_15 may sequentially switch photon detection results of the last 3 pixels 210_45 to 210_47 and transmit the same to the lower one of the plurality of counter data generation circuits 212.

In the second embodiment, one of the plurality of the counter data generation circuits 212 may perform carry addition by looping (24 times) as many times as the sum of assigned bits (sb) of one of the plurality of the SPADs 211 assigned to the SPAD data selection circuit 600 during one exposure cycle. That is, by selection of the SPAD data selection circuit 600, the counter processing of the digital outputs of the 3 of the plurality of SPADs 211 may be performed in series using one signal line.

### (Embodiment 2-11)

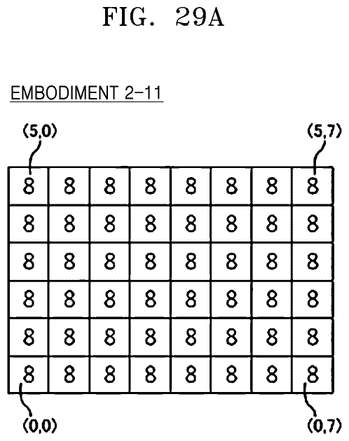

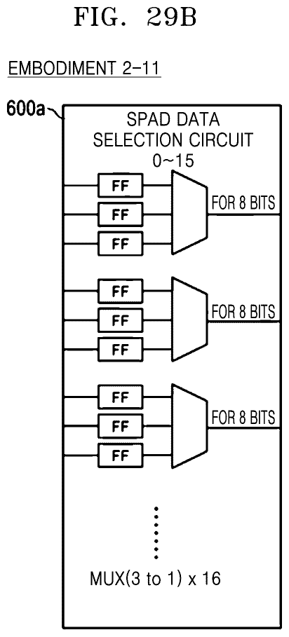

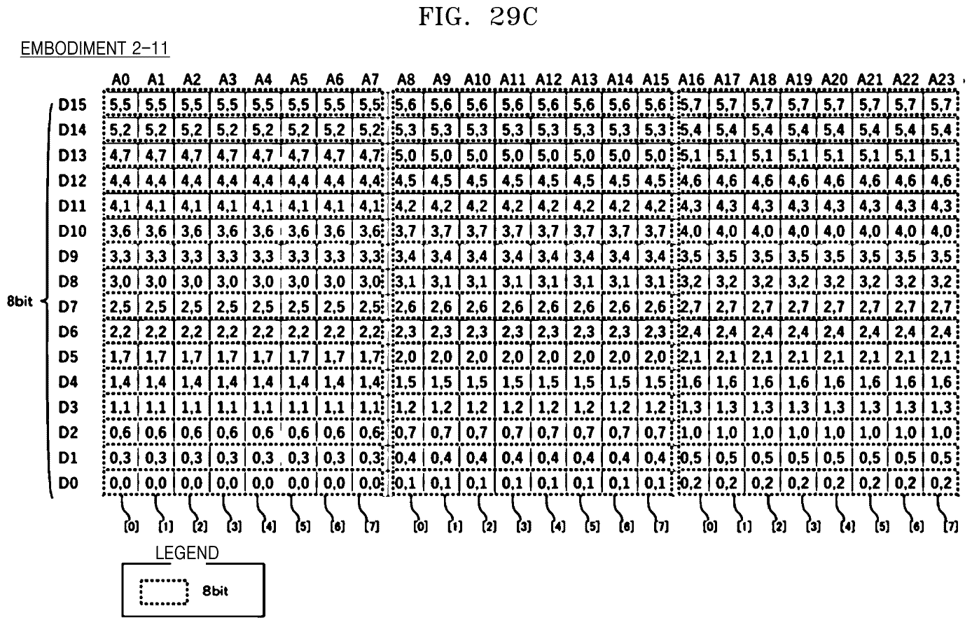

FIG. 29A is a table illustrating an example of the number of counter bits assigned to each pixel in a pixel array, according to an embodiment. The X and Y coordinates of each pixel are related to mapping each pixel to the memory map of FIG. 29C. In embodiment 2-11, 48 pixels (i.e., 8 pixels horizontally×6 pixels vertically) may be configured with 8 counter bits. FIG. 29B is a schematic diagram illustrating the circuit configuration of a plurality of SPAD data selection circuits 600a according to an embodiment. Each of the plurality of SPAD data selection circuits 600 a may include an 8-bit multiplexer and may switch signal lines from 3 of the plurality of SPADs 211 connected thereto. Since all 16 SPAD data selection circuits in the plurality of SPAD data selection circuits 600a have the same configuration, the number of assigned pixels (k) assigned to each of the first to sixteenth SPAD data selection circuits 600a_0 to 600a_15 is the same, that is, 3, and the sum of assigned bits (sb) is likewise 24 bits. Each multiplexer may be connected to 3 of the plurality of SPADs 211 and may sequentially switch the photon detection result of any one of the of the plurality of SPADs 211, according to a selection signal input to the multiplexer, and transmit the same to the lower one of the plurality of counter data generation circuits 212.

FIG. 29C illustrates an example of a memory map within the SRAM 310 in the connection configuration of embodiment 2-11, according to an embodiment. D0 to D15 may correspond to the first to sixteenth SPAD data selection circuits 600a_0 to 600a_15, respectively. For example, 8-bit counters of 3 of the plurality of pixels 210 (coordinates (0,0), (0,1), and (0,2)) corresponding to the first SPAD data selection circuit 600a_0 may be assigned to the address region of arrays (D0,A0) to (D0,A23). The arrays (D0,A0) to (D0,A7) may be assigned to 8-bit counters [0] to [7] of the plurality of pixels 210 (coordinates(0,0)), respectively. As such, by designing the bit width of the SRAM 310 to be the same as the number of SPAD data selection circuits (multiplexer circuits) and the bit length of the SRAM 310 to be the same as the sum of assigned bits (sb), the counting processing of the SRAM 310 may be efficiently performed in units of the multiplexer circuits (i.e., on a row basis) assigned for each bit width.

### (Embodiment 2-12)

Embodiment 2-12 is described with reference to FIGS. 30A to 30C. The configuration of the SPAD data selection circuit 600a and the assignment of the memory map for each of the plurality of pixels 210 shown in the above-described embodiment 2-11 are controlled by the controller 500, and thus may be changed as in embodiment 2-12 described below. For example, by inputting a selection instruction to the controller 500 from the outside, the configuration of embodiment 2-11 may be mutually changed to that of embodiment 2-12 (the same applies to embodiments 2-12 to 2-16 described below).

FIG. 30A is a table illustrating another example of the number of counter bits assigned to each pixel in a pixel array according to an embodiment. The X and Y coordinates of each pixel may be related to mapping each pixel to the memory map of FIG. 30C. In embodiment 2-12, 48 pixels (i.e., 8 pixels horizontally×6 pixels vertically) may be configured with 6, 8, or 12 counter bits. The central pixels are assigned a greater number of counter bits than the peripheral pixels, and the dynamic range of the central pixels may be greater than that of the peripheral pixels. In FIG. 30A, the sum of counter bits may be 384 (bit width (16 bits)×bit length (24 bits)), which is the same as the sum of embodiment 2-11 shown in FIG. 29A (the same applies to embodiments 2-12 to 2-16 described below). FIG. 30B is a schematic diagram illustrating the circuit configuration of a plurality of SPAD data selection circuits 600b, according to an embodiment. A total of 16 SPAD data selection circuits in the plurality of SPAD data selection circuits 600b may be configured with two 6-bit multiplexers, twelve 8-bit multiplexers, and two 12-bit multiplexers. The sum of assigned bits (sb) assigned to each of first to sixteenth SPAD data selection circuits 600b_0 to 600b_15 may be the same, i.e., 24 bits. The number of assigned pixels (k) assigned to each of first to sixteenth SPAD data selection circuits 600b_0 to 600b_15 may be 2, 3, or 4. Each multiplexer may be connected to 4, 3, or 2 of the plurality of SPADs 211 and may sequentially switch the photon detection result of any one of the plurality of SPADS 211, according to a selection signal input to the multiplexer, and transmit the same to the lower one of the plurality of counter data generation circuits 212.

FIG. 30C is a diagram illustrating an example of a memory map within the SRAM 310 in the connection configuration of embodiment 2-12, according to an embodiment. D0 to D15 may correspond to the first to sixteenth SPAD data selection circuits 600b_0 to 600b_15, respectively. For example, the 6-bit counters of the 4 of the plurality of pixels 210 (coordinates (0,0), (0,7), (1,0), and (1,7)) assigned to the first SPAD data selection circuit 600b_0 may be assigned to the address region of arrays (D0,A0) to (D0,A23). The arrays (D0,A0) to (D0,A5) may be assigned the 6-bit counters [0] to [5] of pixel 210_0 (coordinates (0,0)), respectively. The 8-bit counters of the 3 of the plurality of pixels 210 (coordinates (0,1), (0,2), and (0,3)) assigned to the second SPAD data selection circuit 600b_1 may be assigned to the address region of arrays (D1,A0) to (D1,A23). The 12-bit counters of the 2 of the plurality of pixels 210 (coordinates (2,3) and (2,4)) assigned to the seventh SPAD data selection circuit 600b_6 may be assigned to the address region of arrays (D6,A0) to (D6,A23). As such, by designing the bit width of the SRAM 310 to be equal to the number of SPAD data selection circuits (multiplexer circuits) and the bit length of the SRAM 310 to be equal to the sum of assigned bits (sb), the counting processing of the SRAM 310 may be efficiently performed in units of multiplexer circuits assigned for each bit width (i.e., in row units).

### (Embodiment 2-13)

Embodiment 2-13 is described with reference to FIGS. 31A to 31C. The configuration of the plurality of SPAD data selection circuits 600b and the assignment of the memory map for each one of the plurality of pixels 210 shown in the above-described embodiment 2-12 are controlled by the controller 500, and thus may be changed as in embodiment 2-13 described below.

FIG. 31A is a table illustrating another example of the number of counter bits assigned to each pixel in a pixel array according to an embodiment. The X and Y coordinates of each pixel may be related to mapping each pixel to the memory map of FIG. 31C. In embodiment 2-13, 48 pixels (i.e., 8 pixels horizontally×6 pixels vertically) are configured with 6, 8, or 12 counter bits. The central pixels may be assigned a greater number of counter bits than the peripheral pixels, and the dynamic range of the central pixels may be greater than that of the peripheral pixels. In addition, compared to embodiment 2-12, embodiment 2-13 may have a higher ratio of 12 bits. FIG. 31B is a schematic diagram illustrating the circuit configuration of a plurality of SPAD data selection circuits 600c, according to an embodiment. A total of 16 SPAD data selection circuits in the plurality of SPAD data seletion circuits 600c may be configured with four 6-bit multiplexers, eight 8-bit multiplexers, and four 12-bit multiplexers. The sum of assigned bits (sb) assigned to each of first to sixteenth SPAD data selection circuits 600c_0 to 600c_15 may be the same, i.e., 24 bits. The number of assigned pixels (k) assigned to each of the first to sixteenth SPAD data selection circuits 600c_0 to 600c_15 may be 2, 3, or 4. Each multiplexer may be connected to 4, 3, or 2 of the plurality of SPADs 211 and may sequentially switch the photon detection result of any one of the plurality of SPADs 211, according to a selection signal input to the multiplexer, and transmit the same to the lower one of the plurality of counter data generation circuits 212.

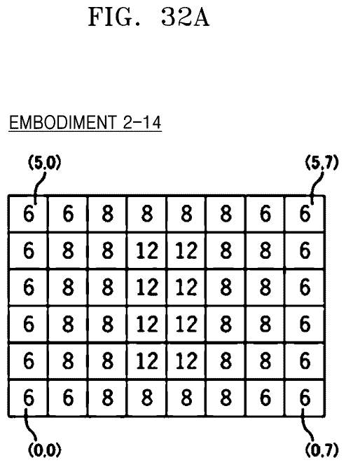

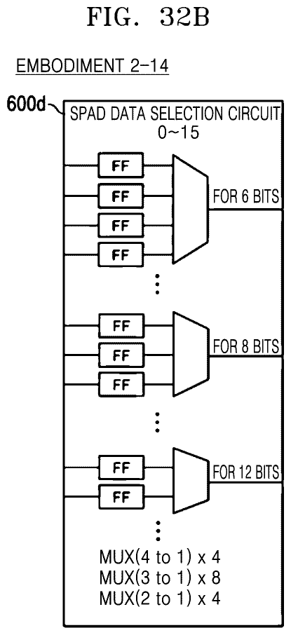

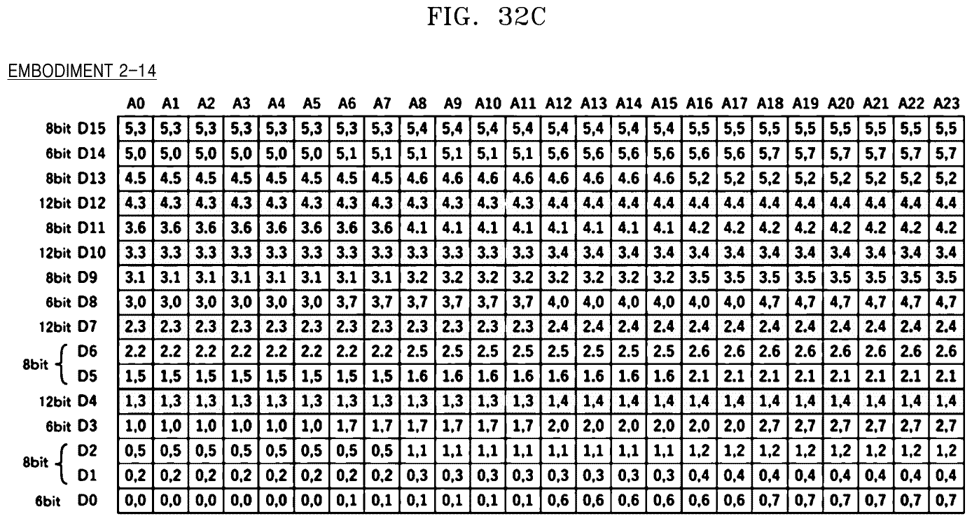

FIG. 31C illustrates an example of a memory map within the SRAM 310 in the connection configuration of embodiment 2-13, according to an embodiment. D0 to D15 may correspond to the first to sixteenth SPAD data selection circuits 600c_0 to 600c_15, respectively. Since the assignment of the address region in the memory map is the same as that shown in FIG. 31C, the description thereof is omitted. In FIG. 31C, the address region assigned to the 12-bit counter is indicated in gray (the same applies to FIG. 32C and the like described below).

### (Embodiment 2-14)

Embodiment 2-14 is described with reference to FIGS. 32A to 32C.

FIG. 32A is a table illustrating another example of the number of counter bits assigned to each pixel in a pixel array according to an embodiment. The X and Y coordinates of each pixel are related to mapping each pixel to the memory map of FIG. 32C. In Embodiment 2-14, 48 pixels (i.e., 8 pixels horizontally×6 pixels vertically) are configured with 6, 8, or 12 counter bits. The central pixels may be assigned a greater number of counter bits than the peripheral pixels, and the dynamic range of the central pixels may be greater than that of the peripheral pixels. Compared to embodiment 2-13, in embodiment 2-14, pixels to which 12-bit counters are assigned may be arranged in the vertical direction (Y direction). FIG. 32B is a schematic diagram illustrating the circuit configuration of a plurality of SPAD data selection circuits 600d according to an embodiment. A total of 16 SPAD data selection circuits of the plurality of SPAD data selection circuits 600d may be configured with four 6-bit multiplexers, eight 8-bit multiplexers, and four 12-bit multiplexers. The sum of assigned bits (sb) assigned to each of first to sixteenth SPAD data selection circuits 600d_0 to 600d_15 may be the same, i.e., 24 bits. The number of assigned pixels (k) assigned to each of the first to sixteenth SPAD data selection circuits 600d_0 to 600d_15 may be 2, 3, or 4. Each multiplexer may be connected to 4, 3, or 2 of the plurality of SPADs 211 and may sequentially switch the photon detection result of any one of the plurality of SPADs 211, according to a selection signal input to the multiplexer, and transmit the same to the lower one of the plurality of counter data generation circuits 212.

FIG. 32C illustrates an example of a memory map within the SRAM 310 in the connection configuration of embodiment 2-14, according to an embodiment. D0 to D15 may correspond to the first to sixteenth SPAD data selection circuits 600d_0 to 600d_15, respectively. Since the assignment of the address region in the memory map is the same as that shown in FIG. 32C, the description thereof is omitted.

### (Embodiment 2-15)

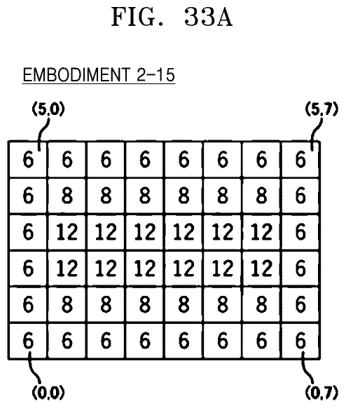

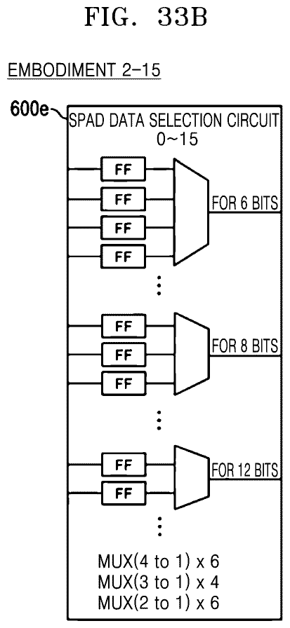

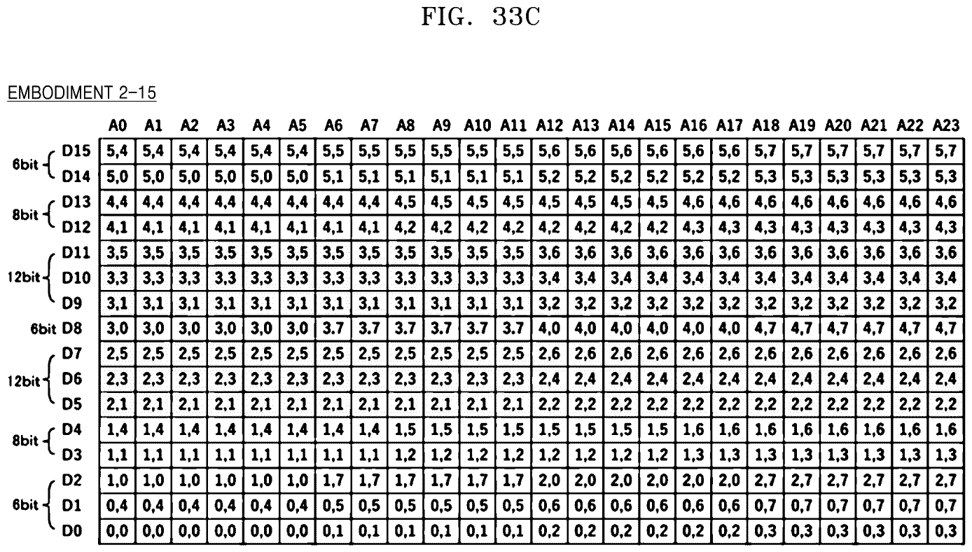

Embodiment 2-15 is described with reference to FIGS. 33A to 33C.

FIG. 33A is a table illustrating another example of the number of counter bits assigned to each pixel in a pixel array according to an embodiment. The X and Y coordinates of each pixel may be related to mapping each pixel to the memory map of FIG. 33C. In embodiment 2-15, 48 pixels (i.e., 8 pixels horizontally×6 pixels vertically) are configured with 6, 8, or 12 counter bits. The central pixels may be assigned a greater number of counter bits than the peripheral pixels, and the dynamic range of the central pixels may be greater than that of the peripheral pixels. Compared with embodiments 2-13 and 2-14, embodiment 2-15 may have a higher ratio of 12 bits.

FIG. 33B is a schematic diagram illustrating the circuit configuration of a plurality of SPAD data selection circuits 600e, according to an embodiment. A total of 16 SPAD data selection circuits of the plurality of SPAD data selection circuits 600e may be configured with six 6-bit multiplexers, four 8-bit multiplexers, and six 12-bit multiplexers. The sum of assigned bits (sb) assigned to each of first to sixteenth SPAD data selection circuits 600e_0 to 600e_15 may be the same, i.e., 24 bits. The number of assigned pixels (k) assigned to each of the first to sixteenth SPAD data selection circuits 600e_0 to 600e_15 may be 2, 3, or 4. Each multiplexer may be connected to 4, 3, or 2 of the plurality of SPADs 211 and may sequentially switch the photon detection result of any one of the plurality of SPADs 211, according to a selection signal input to the multiplexer, and transmit the same to the lower one of the plurality of counter data generation circuit 212.

FIG. 33C illustrates an example of a memory map within the SRAM 310 in the connection configuration of embodiment 2-15, according to an embodiment. D0 to D15 may correspond to the first to sixteenth SPAD data selection circuits 600e_0 to 600e_15, respectively. Since the assignment of the address region in the memory map is the same as that shown in FIG. 33C, the description thereof is omitted.

### (Embodiment 2-16)

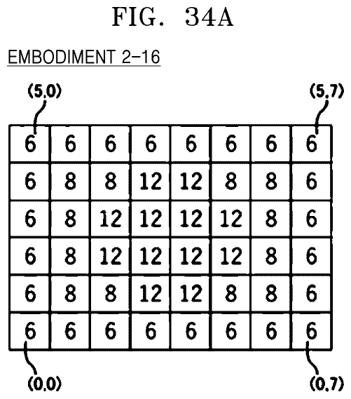

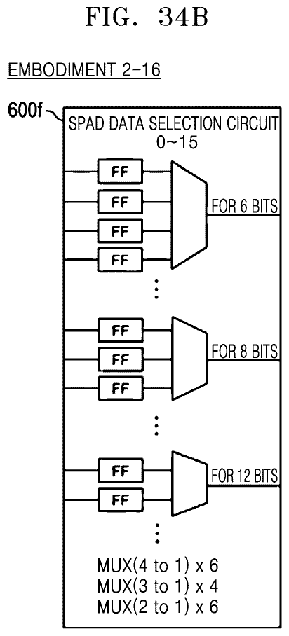

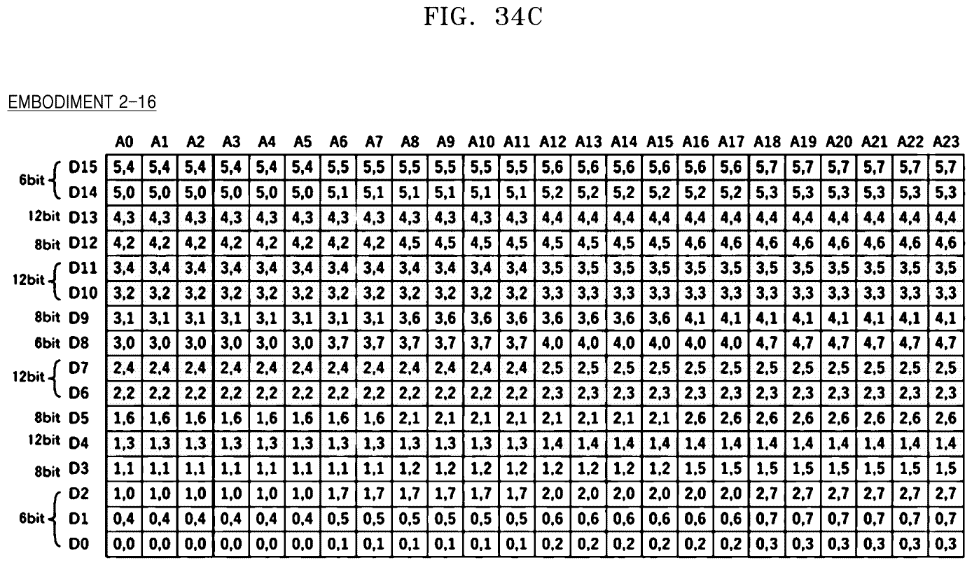

Embodiment 2-16 is described with reference to FIGS. 34A to 34C.

FIG. 34A is a table illustrating another example of the number of counter bits assigned to each pixel in a pixel array according to an embodiment. The X and Y coordinates of each pixel may be related to mapping each pixel to the memory map of FIG. 34C. In Embodiment 2-16, 48 pixels (i.e., 8 pixels horizontally×6 pixels vertically) are configured with 6, 8, or 12 counter bits. The central pixels may be assigned a greater number of counter bits than the peripheral pixels, and the dynamic range of the central pixels may be greater than that of the peripheral pixels. Compared to embodiment 2-15, in embodiment 2-16, the pixels to which 12-bit counters are assigned may be concentrated in the central region and arranged in a circular shape.

FIG. 34B is a schematic diagram illustrating the circuit configuration of a plurality of SPAD data selection circuits 600f, according to an embodiment. A total of 16 SPAD data selection circuits of the plurality of SPAD data selection circuits 600f may be configured with six 6-bit multiplexers, four 8-bit multiplexers, and six 12-bit multiplexers. The sum of assigned bits (sb) assigned to first to sixteenth SPAD data selection circuits 600f_0 to 600f_15 may be the same, that is, 24 bits. The number of assigned pixels (k) assigned to each of the first to sixteenth SPAD data selection circuits 600f_0 to 600f_15 may be 2, 3, or 4. Each multiplexer may be connected to 4, 3, or 2 of the plurality of SPADs 211 and may sequentially switch the photon detection result of any one of the of the plurality of SPADs 211, according to a selection signal input to the multiplexer, and transmit the same to the lower counter data generation circuit 212.

FIG. 34C illustrates an example of a memory map within the SRAM 310 in the connection configuration of embodiment 2-16 according to an embodiment. D0 to D15 may correspond to the first to sixteenth SPAD data selection circuits 600f_0 to 600f_15, respectively. Since the assignment of the address region in the memory map is the same as that shown in FIG. 34C, the description thereof is omitted.

### (Variation of Second Embodiment)

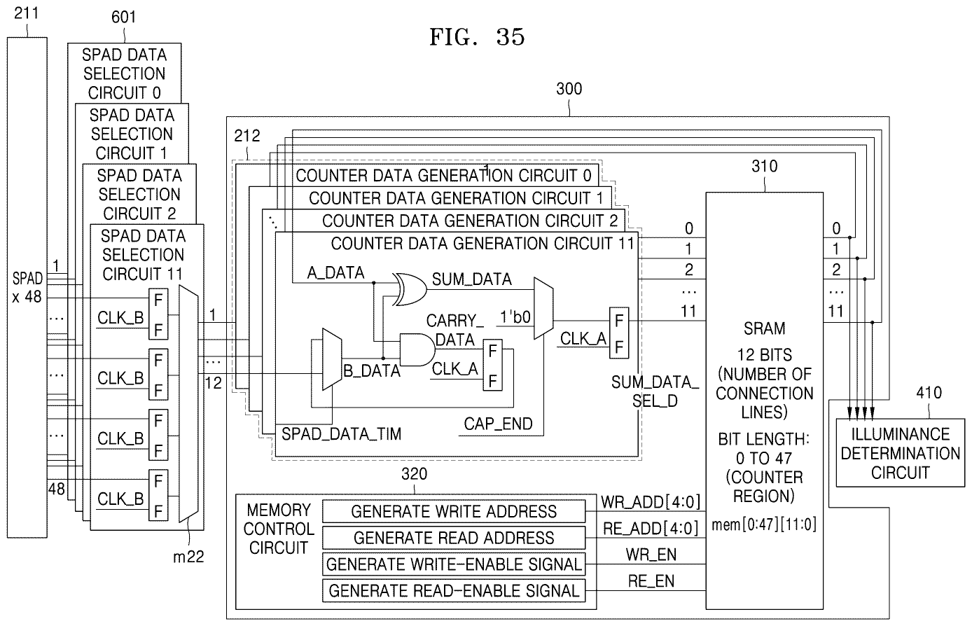

The solid-state imaging device 100 according to the second embodiment is described with reference to FIGS. 35 to 40C. In a variation of the second embodiment, similar to the second embodiment, by using the SPAD data selection circuit 600, the number of counter bits of the plurality of pixels 210 may be configured to be variable when using the counter region of the same bit width and bit length in the SRAM 310, which improves the dynamic range of some pixels 210. FIG. 35 is a schematic diagram of an SPAD data selection circuit 601 and the counter unit 300 in a variation of the second embodiment, according to an embodiment.

In the variation of the second embodiment, the (average) bit length of the counter of each pixel may be 12 bits, and the sum of counter bits of the 48 pixels may be 576. The conditions in the variation of the second embodiment shown in FIG. 35 are as follows.
(SRAM 310)
Bit width (number of connection wires): 12 bits,
Bit length (counter region): 48 bits.
(SPAD Data Selection Circuit 601)
Number of SPAD data selection circuits: 12,
Number of SPADs (k) assigned to each SPAD data selection circuit (number of assigned pixels (k)): 4,
Number of counter bits of SPAD: 12 bits, 12 bits, 12 bits, 12 bits,
Sum of bits of SPADs assigned to each SPAD data selection circuit (sum of assigned bits (sb)): 48 bits.

As shown in the above conditions, since each SPAD data selection circuit 601 is assigned 4 of the plurality of SPADs 211, first to twelfth SPAD data selection circuits 601_0 to 601_11 may be provided corresponding to the 48 of the plurality of SPADs 211. A multiplexer m22 of each of the first to twelfth SPAD data selection circuits 601_0 to 601_11 may sequentially switch and obtain exposure signals in units of 4 pixels among pixels 210_0 to 210_47 and transmit the same to the lower counter data generation circuit 212. For example, the multiplexer m22 of the twelfth SPAD data selection circuit 601_11 may sequentially switch photon detection results of the last 4 pixels 210_44 to 210_47 and transmit the same to the lower one of the plurality of counter data generation circuits 212.

In the variation of the second embodiment, one of the plurality of the counter data generation circuits 212 may perform carry addition by looping (48 times) as many times as the sum of assigned bits (sb) of the one of the plurality of SPADS 211 assigned to the SPAD data selection circuit 601 during one exposure cycle. That is, by selection of the SPAD data selection circuit 601, the counter processing of the digital outputs of the 4 of the plurality of SPADs 211 may be performed in series using one signal line.

### (Embodiment 2-21)

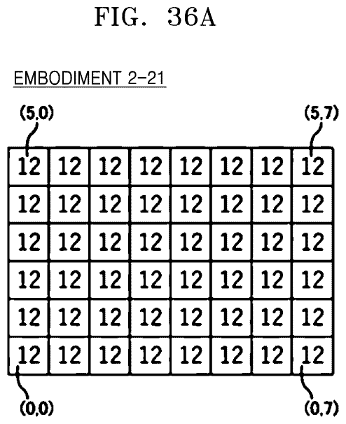

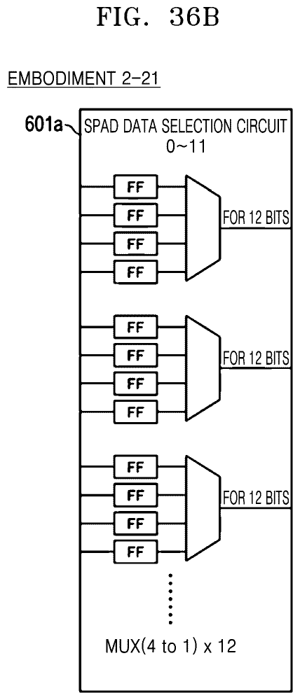

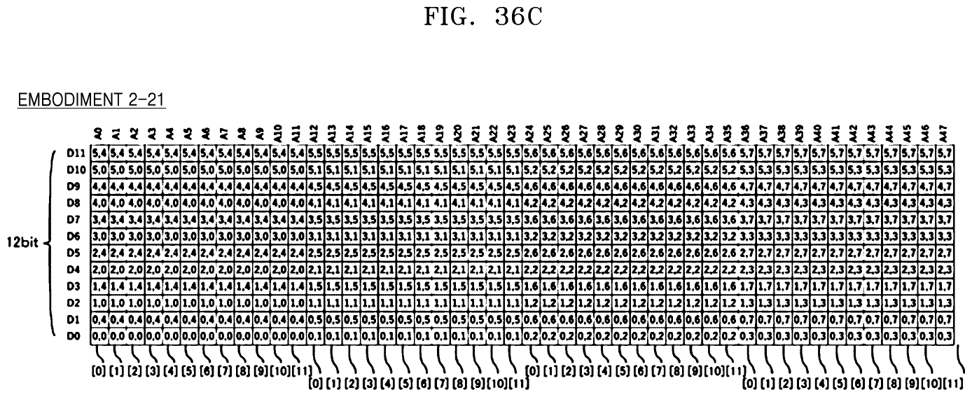

FIG. 36A is a table illustrating another example of the number of counter bits assigned to each pixel in a pixel array according to an embodiment. The X and Y coordinates of each pixel may be related to mapping each pixel to the memory map of FIG. 36C. In embodiment 2-21, 48 pixels (i.e., 8 pixels horizontally×6 pixels vertically) may be configured with 12 counter bits. FIG. 36B is a schematic diagram illustrating the circuit configuration of an SPAD data selection circuit 601a according to an embodiment. The plurality of SPAD data selection circuits 601a may include a 12-bit multiplexer. Since all 12 SPAD data selection circuits of the plurality of SPAD data selection circuits 601a have identical configurations, the sum of assigned bits (sb) assigned to each of first to twelfth SPAD data selection circuits 601a_0 to 601a_11 may be the same, i.e., 48 bits. Each multiplexer may be connected to 4 of the plurality of SPADs 211 and may sequentially switch the photon detection result of any one of the of the plurality of SPADs 211, according to a selection signal input to the multiplexer, and transmit the same to the lower one of the plurality of counter data generation circuits 212.

FIG. 36C illustrates an example of a memory map within the SRAM 310 in the connection configuration of embodiment 2-21 according to an embodiment. D0 to D11 may correspond to the first to twelfth SPAD data selection circuits 601a_0 to 601a_11, respectively. For example, the 12-bit counters of 4 four of the plurality of pixels 210 (coordinates (0,0), (0,1), (0,2), and (0,3)) corresponding to the first SPAD data selection circuit 601a_0 may be assigned to the address region of arrays (D0,A0) to (D0,A23). The arrays (D0,A0) to (D0,A11) may be assigned 12-bit counters [0] to [11] of the pixel 210 (coordinates(0,0)), respectively.

### (Embodiment 2-22)

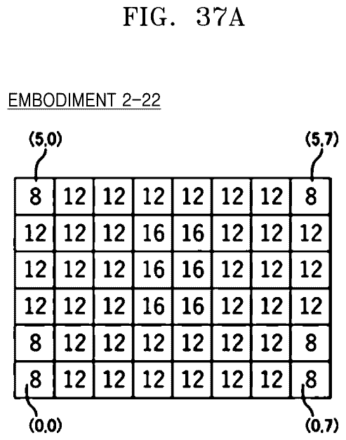

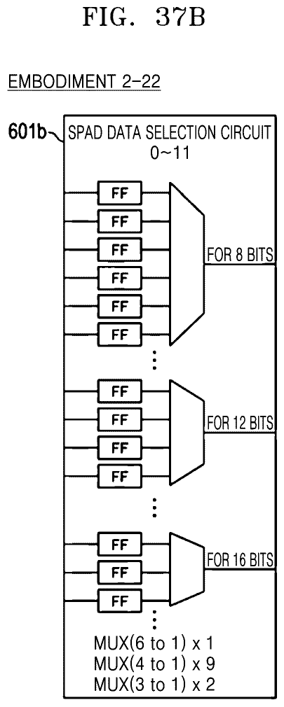

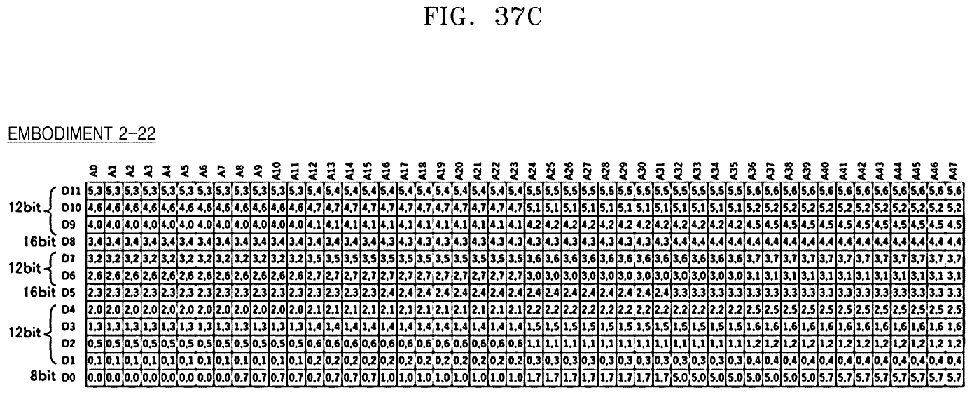

Embodiment 2-22 is described with reference to FIGS. 37A to 37C. The configuration of the plurality of SPAD data selection circuits 601a and the assignment of the memory map for each one of the plurality of pixels 210 shown in the above-described embodiment 2-21 are controlled by the controller 500, and thus may be changed as in embodiment 2-22 described below. For example, by inputting a selection instruction to the controller 500 from the outside, the configuration of embodiment 2-21 may be mutually changed to that of embodiment 2-22 (the same applies to embodiments 2-23 to 2-25 described below).

FIG. 37A is a table illustrating another example of the number of counter bits assigned to each pixel in a pixel array according to an embodiment. The X and Y coordinates of each pixel may be related to mapping each pixel to the memory map of FIG. 37C. In embodiment 2-22, 48 pixels (i.e., 8 pixels horizontally×6 pixels vertically) may be configured with 8, 12, or 16 counter bits. The central pixels are assigned more counter bits than the peripheral pixels, and the dynamic range of the central pixels is greater than that of the peripheral pixels. In FIG. 37A, the sum of counter bits may be 576, which is the same as the sum of embodiment 2-21 shown in FIG. 36A (the same applies to embodiments 2-22 to 2-25 described below). FIG. 37B is a schematic diagram illustrating the circuit configuration of an SPAD data selection circuit 601b, according to an embodiment. A total of 12 of the plurality of SPAD data selection circuits 601b may be configured with one 8-bit multiplexer, nine 12-bit multiplexers, and two 16-bit multiplexers. The sum of assigned bits (sb) assigned to each of first to twelfth SPAD data selection circuits 601b_0 to 601b_11 may be the same, that is, 48 bits. The number of SPADs assigned to each of first to twelfth SPAD data selection circuits 601b_0 to 601b_11 (number of assigned pixels (k)) may be 3, 4, or 6. Each multiplexer may be connected to 6, 4, or 3 of the plurality of SPADs 211 and may sequentially switch the photon detection result of any one of the plurality of SPADs 211, according to a selection signal input to the multiplexer, and transmit the same to the lower one of the plurality of counter data generation circuits 212.

FIG. 37C illustrates an example of a memory map within the SRAM 310 in the connection configuration of embodiment 2-22 according to an embodiment. D0 to D11 may correspond to the first to twelfth SPAD data selection circuits 601b_0 to 601b_11, respectively. For example, the 8-bit counters of 6 of the plurality of pixels 210 (coordinates(0,0), (0,7), (1,0), (1,7), (5,0), and (5,7)) assigned to the first SPAD data selection circuit 601b_0 may be assigned to the address region of arrays (D0,A0) to (D0,A47). The 12-bit counters of the 4 of the plurality of pixels 210 (coordinates (0,1), (0,2), (0,3), and (0,4)) assigned to the second SPAD data selection circuit 601b_1 may be assigned to the address region of arrays (D1,A0) to (D1,A47). The 16-bit counters of the 3 of the plurality of pixels 210 (coordinates (2,3), (2,4), and (3,3)) assigned to the sixth SPAD data selection circuit 601b_5 may be assigned to the address region of arrays (D5,A0) to (D5,A47).

### (Embodiment 2-23)

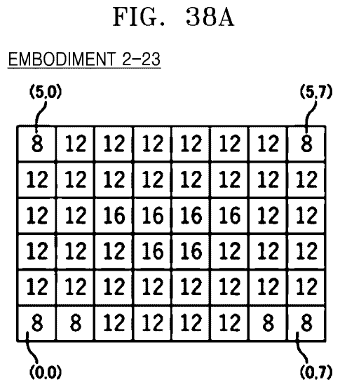

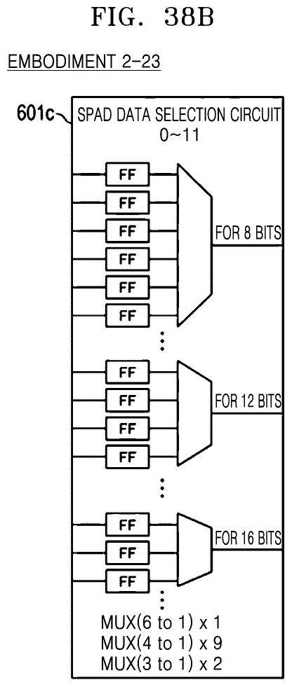

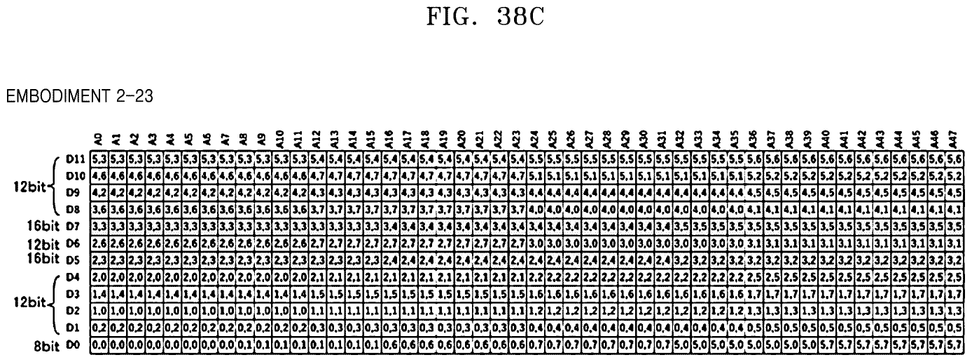

Embodiment 2-23 is described with reference to FIGS. 38A to 38C.

FIG. 38A is a table illustrating another example of the number of counter bits assigned to each pixel in a pixel array according to an embodiment. The X and Y coordinates of each pixel may be related to mapping each pixel to the memory map of FIG. 38C. In embodiment 2-23, 48 pixels (i.e., 8 pixels horizontally×6 pixels vertically) may be configured with 8, 12, or 16 counter bits. The central pixels are assigned more counter bits than the peripheral pixels, and the dynamic range of the central pixels is greater than that of the peripheral pixels. Compared to embodiment 2-22, in embodiment 2-23, pixels to which 16-bit counters are assigned may be arranged in the horizontal direction (X direction). FIG. 38B is a schematic diagram illustrating the circuit configuration of a plurality of SPAD data selection circuits 601c, according to an embodiment. A total of 12 SPAD data selection circuits of the plurality of SPAD data selection circuits 601c may be configured with one 8-bit multiplexer, nine 12-bit multiplexers, and two 16-bit multiplexers. The sum of assigned bits (sb) assigned to each of first to twelfth SPAD data selection circuits 601c_0 to 601c_11 may be the same, that is, 48 bits. The number of SPADs (k) assigned to each of the first to twelfth SPAD data selection circuits 601c_0 to 601c_11 may be 3, 4, or 6. Each multiplexer may be connected to 6, 4, or 3 of the plurality of SPADs 211 and may sequentially switch the photon detection result of any one of the of the plurality of SPADs 211, according to a selection signal input to the multiplexer, and transmit the same to the lower one of the plurality of counter data generation circuits 212.

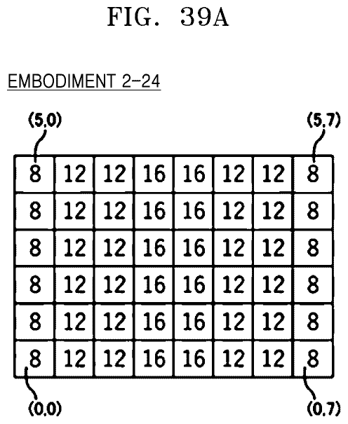

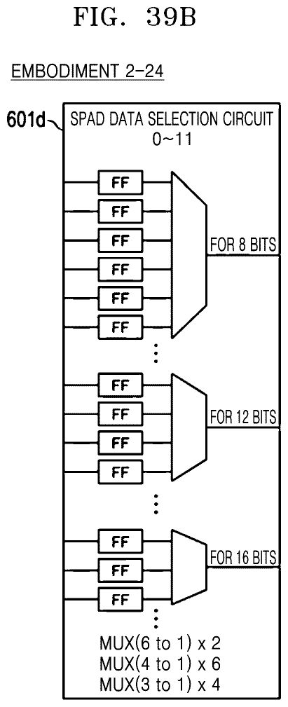

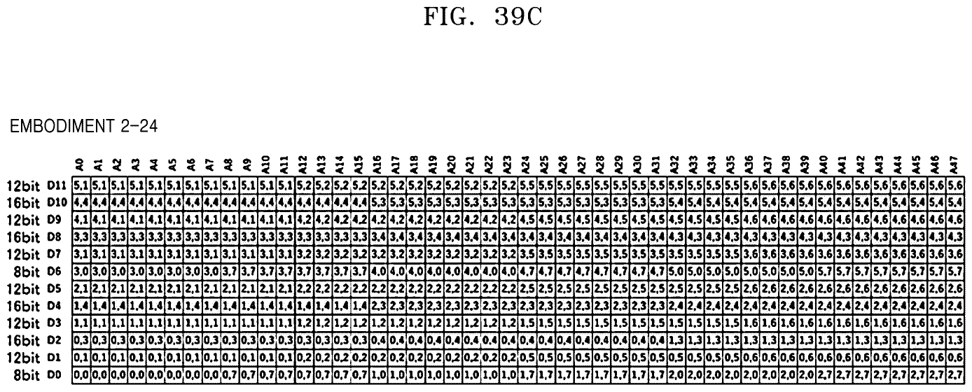

FIG. 38C illustrates an example of a memory map within the SRAM 310 in the connection configuration of embodiment 2-23 according to an embodiment. D0 to D11 may correspond to the first to twelfth SPAD data selection circuits 601c_0 to 601c_11, respectively. Since the assignment of the address region in the memory map is the same as that shown in FIG. 38C, the description thereof is omitted. In FIG. 38C, the address region assigned to the 16-bit counter is shown in gray (the same applies to FIG. 39C described below).

### (Embodiment 2-24)

Embodiment 2-24 is described with reference to FIGS. 39A to 39C.

FIG. 39A is a table illustrating another example of the number of counter bits assigned to each pixel in a pixel array according to an embodiment. The X and Y coordinates of each pixel are related to mapping each pixel to the memory map of FIG. 39C. In embodiment 2-24, 48 pixels (i.e., 8 pixels horizontally×6 pixels vertically) may be configured with 8, 12, or 16 counter bits. The central pixels are assigned more counter bits than the peripheral pixels, and the dynamic range of the central pixels is greater than that of the peripheral pixels. Compared with embodiment 2-23, embodiment 2-24 may have a higher ratio of 12 bits. FIG. 39B is a schematic diagram illustrating the circuit configuration of a plurality of SPAD data selection circuits 601d, according to an embodiment. A total of 12 SPAD data selection circuits of the plurality of SPAD data selection circuits 601d may be configured with two 8-bit multiplexers, six 12-bit multiplexers, and four 16-bit multiplexers. The sum of assigned bits (sb) assigned to each of first to twelfth SPAD data selection circuits 601d_0 to 601d_11 may be the same, that is, 48 bits. The number of SPADs assigned to each of the first to twelfth SPAD data selection circuits 601d_0 to 601d_11 (number of assigned pixels (k)) may be 3, 4, or 6. Each multiplexer may be connected to 6, 4, or 3 of the plurality of SPADs 211 and may sequentially switch the photon detection result of any one of the of the plurality of SPADs 211, according to a selection signal input to the multiplexer, and transmit the same to the lower one of the plurality of counter data generation circuits 212.

FIG. 39C illustrates an example of a memory map within the SRAM 310 in the connection configuration of embodiment 2-24 according to an embodiment. D0 to D11 may correspond to the first to twelfth SPAD data selection circuits 601d_0 to 601d_11, respectively. Since the assignment of the address region in the memory map is the same as that shown in FIG. 39C, the description thereof is omitted.

### (Embodiment 2-25)

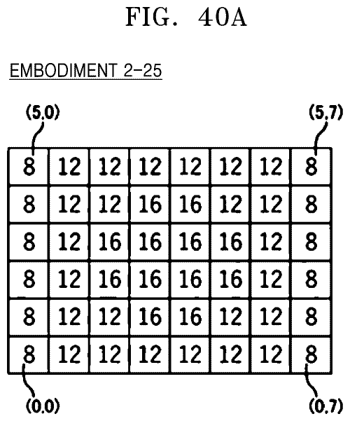

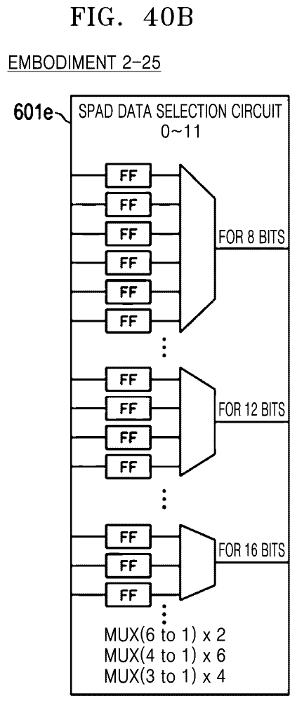

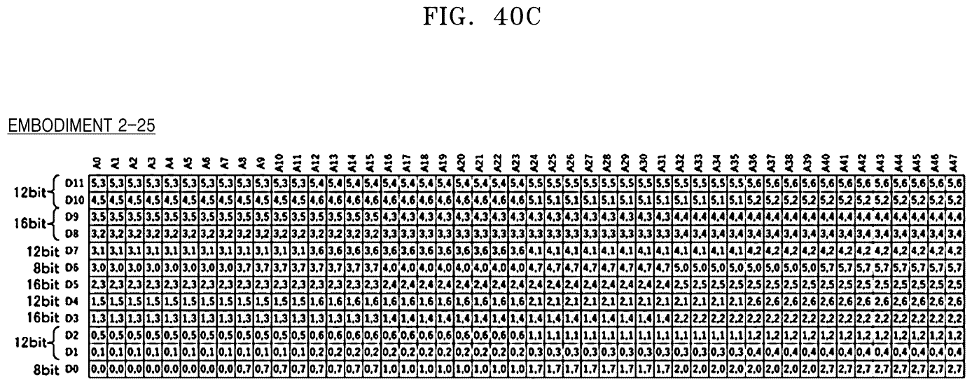

Embodiment 2-25 is described with reference to FIGS. 40A to 40C.

FIG. 40A is a table illustrating another example of the number of counter bits assigned to each pixel in a pixel array according to an embodiment. The X and Y coordinates of each pixel are related to mapping each pixel to the memory map of FIG. 40C. In embodiment 2-25, 48 pixels (i.e., 8 pixels horizontally×6 pixels vertically) may be configured with 8, 12, or 16 counter bits. The central pixels are assigned more counter bits than the peripheral pixels, and the dynamic range of the central pixels is greater than that of the peripheral pixels. Compared to embodiment 2-24, in embodiment 2-25, the pixels to which 16-bit counters are assigned may be concentrated in the central region. FIG. 40B is a schematic diagram illustrating the circuit configuration of a plurality of SPAD data selection circuits 601e, according to an embodiment. A total of 12 SPAD data selection circuits of the plurality of SPAD data selection circuits 601e may be configured with two 8-bit multiplexers, six 12-bit multiplexers, and four 16-bit multiplexers. The sum of assigned bits (sb) assigned to each of first to twelfth SPAD data selection circuits 601e_0 to 601e_11 may be the same, that is, 48 bits. The number of SPADs (k) assigned to each of the first to twelfth SPAD data selection circuits 601e_0 to 601e_11 may be 3, 4, or 6. Each multiplexer may be connected to 6, 4, or 3 of the plurality of SPADs 211 and may sequentially switch the photon detection result of any one of the of the plurality of SPADs 211, according to a selection signal input to the multiplexer, and transmit the same to the lower one of the plurality of counter data generation circuits 212.

FIG. 40C illustrates an example of a memory map within the SRAM 310 in the connection configuration of embodiment 2-25 according to an embodiment. D0 to D 11 may correspond to the first to twelfth SPAD data selection circuits 601e_0 to 601e_11, respectively. Since the assignment of the address region in the memory map is the same as that shown in FIG. 40C, the description thereof is omitted.

### (Configuration of First and Second SPAD Data Selection Units)

In the second embodiment, the solid-state imaging device 100 may include a first SPAD data selection unit and a second SPAD data selection unit. The first SPAD data selection unit may be assigned first SPADs corresponding to a counter of a first bit length, select one of the assigned first SPADs, and transmit a digital output of the selected SPAD to the counter data generation circuit. The second SPAD data selection unit may be assigned second SPADs corresponding to a counter of a second bit length different from the first bit length, select one of the assigned second SPADs, and transmit a digital output of the selected SPAD to the counter data generation circuit.

For example, in embodiment 2-12, in relation to the first and second SPAD data selection circuits 600b_0 and 600b_1, the first SPAD data selection circuit 600b_0 for 6 bits, as the first bit length, may correspond to the first SPAD data selection unit. The second SPAD data selection circuit 600b_1 for 8 bits, as the second bit length, may correspond to the second SPAD data selection unit. The number of first SPADs assigned to the first SPAD data selection unit (number of assigned pixels (k)) may be 4, and the number of second SPADs assigned to the second SPAD data selection unit (number of assigned pixels (k)) may be different therefrom, i.e., 3. The sum of the first bit lengths of the first SPADs assigned to the first SPAD data selection unit (sum of assigned bits (sb)) and the sum of the second bit lengths of the second SPADs assigned to the second SPAD data selection unit (sum of assigned bits (sb)) may be the same, i.e., 24 bits.

Alternatively, in relation to the second and seventh SPAD data selection circuits 600b_1 and 600b_6, the second SPAD data selection circuit 600b_1 for 8 bits, as the first bit length, may correspond to the first SPAD data selection unit. The seventh SPAD data selection circuit 600b_6 for 12 bits, as the second bit length, may correspond to the second SPAD data selection circuit. The number of first SPADs assigned to the first SPAD data selection unit (number of assigned pixels (k)) may be 3, the number of second SPADs assigned to the second SPAD data selection unit (number of assigned pixels (k)) may be 2, and the sum of assigned bits (sb) may be the same, that is, 24 bits.

### (Variation in Number and Position)

The number of SPADs assigned to the SPAD data selection unit (number of assigned pixels (k)) may be variable. For example, for the sixth SPAD data selection circuit 600b_5 corresponding to array row D5, the number of assigned SPADs (number of assigned pixels (k)) in FIG. 30C is 3 (8 bits). However, it may be changed to 4 (6 bits) in embodiment 2-13 (FIG. 31C) and to 2 (12 bits) in embodiment 2-15 (FIG. 33C) by the controller 500.

Additionally, the positions of the pixels assigned to the SPAD data selection unit in the pixel array may be variable. For example, for the same sixth SPAD data selection circuit 600b_5, the positions of the assigned pixels in FIG. 30C may be (2,0), (2,1), and (2,2), but may be changed by the controller 500 to (1,0), (1,7), (2,0), and (2,7) in embodiment 2-13 (FIG. 31C). In addition, in embodiment 2-14 (FIG. 32C), the positions of the assigned pixels in the same 8 bits may be changed to (1,5), (1,6), and (2,1).

The disclosure may achieve the following effects by the following configuration.

(1) The solid-state imaging device according to the disclosure may include a plurality of pixels and a counter unit. Each of the plurality of pixels may include an SPAD, and the counter unit may include a counter data generation circuit corresponding to the SPAD and a memory unit. The memory unit may include a counter corresponding to each pixel, wherein the counter data generation circuit may perform addition processing that sequentially performs carry addition for each designated digit during counting of the number of photons in the SPAD, and recording processing that sequentially records the addition result in the counter for each designated digit. Therefore, the circuit scale to be arranged in the pixel region may be reduced and high-resolution imaging may be achieved.

(2) Each counter data generation circuit may be connected to the memory unit by a number of connection wires having designated digits. The memory unit may include an SRAM. These configurations may reduce the circuit scale in the solid-state imaging device.

(3) By performing the sequential processing of addition and recording processing in an equalized manner within one exposure cycle, a peak current may be suppressed.

(4) The solid-state imaging device may include an illuminance determination unit (also referred to as an illuminance determination circuit) that determines the illuminance of incident light incident on each pixel based on a count value of the number of photons in the SPAD, and an exposure controller (also referred to as an exposure control circuit) that controls the exposure time of the SPAD according to the illuminance of the incident light of the SPAD determined by the illuminance determination unit. Thus, in a low-illuminance imaging environment, the exposure time may be made longer, and in a high-illuminance imaging environment, the exposure time may be made shorter, which enables high-sensitivity imaging while preventing saturation under high illuminance and achieving a higher dynamic range.

(5) The illuminance determination unit may be shared by a plurality of pixels or a plurality of exposure controllers. This may reduce the circuit scale of the solid-state imaging device.

(6) The solid-state imaging device may also include an SPAD data selection unit (also referred to as an SPAD data selection circuit) that assigns a plurality of SPADs corresponding to a counter of a designated bit length, selects any one of the assigned plurality of SPADs, and transmits the digital output of the selected SPAD to the counter data generation circuit.

The SPAD data selection unit may include a first SPAD data selection unit and a second SPAD data selection unit. The first SPADs corresponding to a counter having a first bit length may be assigned to the first SPAD data selection unit, and the second SPADs corresponding to a counter having a second bit length different from the first bit length may be assigned to the second SPAD data selection unit. In addition, the number of first SPADs assigned to the first SPAD data selection unit may be different from the number of second SPADs assigned to the second SPAD data selection unit, and the sum of the first bit lengths of the first SPADs assigned to one first SPAD data selection unit may be equal to the sum of the second bit lengths of the second SPADs assigned to one second SPAD data selection unit. In addition, the number of first SPADs assigned to the first SPAD data selection unit and the number of second SPADs assigned to the second SPAD data selection unit may be variable. This configuration enables a structure to vary the number of counter bits using the SRAM having the same bit width and bit length, thereby improving the dynamic range of some pixels in the pixel array. For example, the dynamic range of pixels in the central region may be improved, compared to pixels in the peripheral region.

The configuration of the solid-state imaging device 100 described above is described mainly to explain the features of the foregoing embodiments and is not limited to the above configuration. Various modifications may be made without departing from the scope of the claims. The configuration is not limited to excluding the general solid-state imaging device 100 or the like.

While the disclosure has been particularly shown and described with reference to embodiments and variations thereof, it will be understood that various changes in form and details, as well as combinations, substitutions, or integrations of features among the embodiments and variations, may be made therein without departing from the spirit and scope of the following claims.

What is claimed is:

1. A solid-state imaging device comprising:
a pixel array in which a plurality of pixels are arranged, the plurality of pixels comprising a plurality of single-photon avalanche diodes (SPADs); and
a counter unit comprising:
a plurality of counter data generation circuits corresponding to the plurality of SPADs; and
a memory unit comprising a plurality of counters corresponding to the plurality of pixels,
wherein each of the plurality of counter data generation circuits are configured to perform:
addition processing that sequentially performs carry addition for each designated digit during counting of a number of photons incident on corresponding one of the plurality of the SPADs, and
recording processing that sequentially records an addition result in the counter for each designated digit.

2. The solid-state imaging device of claim 1, wherein each of the plurality of the counter data generation circuits is further configured to be connected to the memory unit through a number of connection wires corresponding to the designated digit.

3. The solid-state imaging device of claim 1, further comprising a memory control circuit, wherein the addition processing adds bit data of the designated digit of the counter and carry bit data corresponding to the designated digit during the counting, based on address control by the memory control circuit.

4. The solid-state imaging device of claim 3, wherein the recording processing records the addition result obtained through the addition processing in the designated digit of the counter based on address control by the memory control circuit.

5. The solid-state imaging device of claim 1, wherein the memory unit comprises a static random-access memory (SRAM).

6. The solid-state imaging device of claim 1, wherein the addition processing and the recording processing are performed in an equalized manner within one exposure cycle.

7. The solid-state imaging device of claim 1, further comprising:
an illuminance determination circuit configured to determine illuminance of incident light incident on each of the plurality of pixels based on a count value of a number of photons incident on the corresponding one of the plurality of SPADs; and
an exposure control circuit configured to control an exposure time of the corresponding one of the plurality of SPADs according to the illuminance of incident light determined by the illuminance determination circuit.

8. The solid-state imaging device of claim 7, wherein the illuminance determination circuit is shared by the plurality of pixels or by a plurality of exposure control circuits.

9. The solid-state imaging device of claim 1, further comprising a plurality of SPAD data selection circuits, one of the plurality of SPAD data selection circuit being configured to:
assign at least one of the plurality of SPADs corresponding to a counter of a designated bit length,
select any one SPAD from among the assigned plurality of SPADs, and
transmit a digital output of the selected SPAD to the corresponding one of the plurality of counter data generation circuits.

10. The solid-state imaging device of claim 9, wherein the plurality of SPAD data selection circuits comprises:
a first SPAD data selection circuit to which first SPADs corresponding to a counter of a first bit length are assigned, and
a second SPAD data selection circuit to which second SPADs corresponding to a counter of a second bit length that is greater than the first bit length are assigned.

11. The solid-state imaging device of claim 10, wherein a number of first SPADs assigned to the first SPAD data selection circuit is different from a number of second SPADs assigned to the second SPAD data selection circuit, and
a sum of first bit lengths of the first SPADs assigned to the first SPAD data selection circuit is identical to a sum of second bit lengths of the second SPADs assigned to the second SPAD data selection circuit.

12. The solid-state imaging device of claim 9, wherein a number of the plurality of SPADs assigned to the SPAD data selection circuit is variable.

13. The solid-state imaging device of claim 9, wherein, in the pixel array, positions of the plurality of SPADs assigned to the SPAD data selection circuit are variable.

14. A method of operating a solid-state imaging device including a pixel array in which a plurality of pixels are arranged, and a memory unit, wherein each of the plurality of pixels comprises a single-photon avalanche diode (SPAD), the method comprising:
setting an exposure time of a next frame based on illuminance detected in a previous frame;
performing exposure in the SPAD during the set exposure time;
performing addition processing that sequentially performs carry addition for each designated digit during counting of a number of photons incident on the SPAD during the exposure time;
performing recording processing that sequentially records a result of the addition processing in a counter of the memory unit for each designated digit; and
generating image data based on the exposure time and a count value of the number of photons.

15. The method of claim 14, wherein the solid-state imaging device further includes a memory control circuit, and the performing of the addition processing comprises adding bit data of a designated digit of the counter and carry bit data corresponding to the designated digit during the counting, based on address control by the memory control circuit.

16. The method of claim 15, wherein the performing of the recording processing comprises recording an addition result obtained through the addition processing in the designated digit of the counter, based on address control by the memory control circuit.

17. The method of claim 14, wherein the setting of the exposure time comprises determining an illuminance of incident light incident on each of the plurality of pixels based on the count value of the number of photons, and setting an exposure time of the next frame according to the determined illuminance of incident light.

18. The method of claim 14, wherein the solid-state imaging device further includes a counter data generation circuit, and the method further comprises:
assigning a plurality of SPADs corresponding to a counter of a designated bit length,
selecting any one SPAD from among the assigned plurality of SPADs, and
transmitting a digital output of the selected SPAD to the counter data generation circuit.

19. The method of claim 14, wherein the memory unit includes a static random-access memory (SRAM).

20. A counter unit comprising:
a counter data generation circuit;
a static random-access memory (SRAM); and
a memory control circuit,
wherein the counter data generation circuit is configured to perform:
addition processing that sequentially performs carry addition for each designated digit, based on address control by the memory control circuit, during counting of a number of photons input to a single-photon avalanche diode (SPAD) of each pixel for an exposure time, and
perform recording processing that sequentially records a result of the addition processing in the SRAM for each designated digit based on the address control.
